(19) United States
(12) Patent Application Publication
(10) Pub. No.: US 2024/0069142 A1
(43) Pub. Date: Feb. 29, 2024

(54) POSITIONING MEASUREMENT REPORT COMPRESSION

(71) Applicant: QUALCOMM Incorporated, San Diego, CA (US)

(72) Inventors: Srinivas YERRAMALLI, San Diego, CA (US); Mukesh KUMAR, Hyderabad, Punjab (IN); Alexandros MANOLAKOS, Escondido, CA (US)

(21) Appl. No.: 18/261,056

(22) PCT Filed: Mar. 16, 2022
(86) PCT No.: PCT/US2022/071187

§ 371 Date: Jul. 11, 2023

(30) Foreign Application Priority Data
Mar. 23, 2021 (IN) 202141012373

(51) Int. Cl. G01S 5/02; G01S 5/00; H04W 64/00

(52) U.S. Cl. CPC G01S 5/0236; G01S 5/0036; H04W 64/00

(57) ABSTRACT

Information inherently conveyed in the hierarchical structure of a positioning frequency layer is leveraged to determine a sequence identifier unique to each Positioning Reference Signal (PRS) resource of a sequence of PRS resources used in a positioning session of a user equipment (UE). This unique sequence number can then be used in the reporting of measurement data by the UE or other reporting device to a location server. As such, embodiments herein effectively provide means for compressing identification information included in position measurement reporting to the location server.

### BACKGROUND

### 1. Field of Invention

The present invention relates generally to the field of wireless communications, and more specifically to determining the location of a User Equipment (UE) using radio frequency (RF) signals.

### 2. Description of Related Art

The determination of an position of a mobile UE in a wireless communication network, often referred to as “positioning” of the UE, may be performed using any of a variety of position-determining techniques. Many of these techniques may comprise, for example, transmission of reference signals by one or more Transmission Reception Points (TRPs) of the wireless communication network, and the measurement of these reference signals by the UE. These measurements can be indicative of distances and/or angles between the UE and one or more TRPs, enabling the position of the UE to be determined multiangulation, multilateration, and/or other geometrically-based techniques.

The position determination of a UE often uses multiple measurements involving multiple reference signals. And each reference signal may be identified uniquely by both the network and UE. Reference signals are typically part of a large hierarchical structure and may require a large amount of signaling overhead to uniquely identify.

### BRIEF SUMMARY

An example method of efficient reporting of position measurements taken by a user equipment (UE) in a wireless communication network, according to this disclosure, comprises receiving, at a wireless node, assistance data (AD) from a location server during a positioning session, where the AD includes identifying information for at least a first position reference signal (PRS) resource of a plurality of PRS resources to be measured by the UE. The method also includes obtaining, at the wireless node, measurement information regarding the first PRS resource. The method also includes sending a first measurement report from the wireless node to the location server, where the first measurement report may comprise: the measurement information regarding the first PRS resource, and a sequence identifier of the first PRS resource, wherein the sequence identifier of the first PRS resource is generated from the identifying information for the first PRS resource, and wherein the sequence identifier of the first PRS resource is unique within the positioning session among sequence identifiers of the plurality of PRS resources.

An example method of enabling efficient reporting of position measurements taken by a user equipment (UE) in a wireless communication network, according to this disclosure, comprises determining, at a location server, identifying information for each position reference signal (PRS) resource of a plurality of PRS resources to be measured by the UE during a positioning session The method also comprises sending assistance data (AD) to a wireless node, where the AD may comprise, for each PRS resource of the plurality of PRS resources, a sequence identifier of the respective PRS resource generated from the identifying information of the respective PRS resource, wherein the sequence identifier is unique within the positioning session among sequence identifiers of the plurality of PRS resources.

An example wireless node enabling efficient reporting of position measurements taken by a user equipment (UE) in a wireless communication network, according to this disclosure, comprises a transceiver, a memory, and one or more processing units communicatively coupled with the transceiver and the memory. The one or more processing units are configured to receive, via the transceiver, assistance data (AD) from a location server during a positioning session, where the AD includes identifying information for at least a first position reference signal (PRS) resource of a plurality of PRS resources to be measured by the UE during. The one or more processing units are also configured to obtain measurement information regarding the first PRS resource. The one or more processing units are also configured to send, via the transceiver, a first measurement report from the wireless node to the location server, where the first measurement report may comprise the measurement information regarding the first PRS resource; and a sequence identifier of the first PRS resource, wherein the sequence identifier of the first PRS resource is generated from the identifying information for the first PRS resource, and wherein the sequence identifier of the first PRS resource is unique within the positioning session among sequence identifiers of the plurality of PRS resources.

An example location server enabling efficient reporting of position measurements taken by a user equipment (UE) in a wireless communication network, according to this disclosure, comprises a transceiver, a memory, and one or more processing units communicatively coupled with the transceiver and the memory. The one or more processing units are configured to determine identifying information for each position reference signal (PRS) resource of a plurality of PRS resources to be measured by the UE during a positioning session. The one or more processing units are also configured to send assistance data (AD) to a wireless node via the transceiver, where the AD may comprise, for each PRS resource of the plurality of PRS resources, a sequence identifier of the respective PRS resource generated from the identifying information of the respective PRS resource, wherein the sequence identifier is unique within the positioning session among sequence identifiers of the plurality of PRS resources.

An example apparatus, according to this disclosure, comprises means for receiving assistance data (AD) from a location server during a positioning session, where the AD includes identifying information for at least a first position reference signal (PRS) resource of a plurality of PRS resources to be measured by a user equipment (UE). The apparatus also comprises means for obtaining measurement information regarding the first PRS resource. The apparatus also comprises means for sending a first measurement report from the wireless node to the location server, where the first measurement report may comprise: the measurement information regarding the first PRS resource, and a sequence identifier of the first PRS resource, wherein the sequence identifier of the first PRS resource is generated from the identifying information for the first PRS resource, and wherein the sequence identifier of the first PRS resource is unique within the positioning session among sequence identifiers of the plurality of PRS resources.

Another example apparatus, according to this disclosure, comprises means for determining identifying information for each position reference signal (PRS) resource of a plurality of PRS resources to be measured by the UE during a positioning session. The apparatus also comprises means for sending assistance data (AD) to a wireless node, where the AD may comprise, for each PRS resource of the plurality of PRS resources, a sequence identifier of the respective PRS resource generated from the identifying information of the respective PRS resource, wherein the sequence identifier is unique within the positioning session among sequence identifiers of the plurality of PRS resources.

An example a non-transitory computer-readable medium, according to this disclosure, stores instructions for efficient reporting of position measurements taken by a user equipment (UE) in a wireless communication network. The instructions comprise code for receiving, at a wireless node, assistance data (AD) from a location server during a positioning session, where the AD includes identifying information for at least a first position reference signal (PRS) resource of a plurality of PRS resources to be measured by the UE. The instructions also comprise code for obtaining, at the wireless node, measurement information regarding the first PRS resource. The instructions also comprise code for sending a first measurement report from the wireless node to the location server, where the first measurement report may comprise the measurement information regarding the first PRS resource, and a sequence identifier of the first PRS resource, wherein the sequence identifier of the first PRS resource is generated from the identifying information for the first PRS resource, and wherein the sequence identifier of the first PRS resource is unique within the positioning session among sequence identifiers of the plurality of PRS resources.

An example a non-transitory computer-readable medium, according to this disclosure, stores instructions for enabling efficient reporting of position measurements taken by a user equipment (UE) in a wireless communication network. The instructions comprise code for determining, at a location server, identifying information for each position reference signal (PRS) resource of a plurality of PRS resources to be measured by the UE during a positioning session. The instructions also comprise code for sending assistance data (AD) to a wireless node, wherein the AD comprises, for each PRS resource of the plurality of PRS resources, a sequence identifier of the respective PRS resource generated from the identifying information of the respective PRS resource, wherein the sequence identifier is unique within the positioning session among sequence identifiers of the plurality of PRS resources.

### BRIEF DESCRIPTION OF THE DRAWINGS

FIG. 1 is a diagram of a positioning system, according to an embodiment.

FIG. 2 is a diagram of a 5th Generation (5G) New Radio (NR) positioning system, illustrating an embodiment of a positioning system (e.g., the positioning system of FIG. 1) implemented within a 5G NR communication system.

FIG. 3 is a call-flow diagram that illustrates a basic exchange of assistance data (AD) and measurement data reporting between a user equipment (UE) and location server, according to an embodiment.

FIGS. 4 and 5 are diagrams of an example hierarchical structure of PRS resources, PRS resource sets, Transmission Reception Points (TRPs) of a Positioning Frequency Layer (PFL), according to an embodiment.

FIGS. 6 and 7 are call-flow diagrams that illustrates different embodiments in which PRS resource sequence ID information is used.

FIG. 8 is a diagram of an example hierarchical structure similar to FIG. 5, but with a prefix to the PRS resource sequence IDs, according to an embodiment.

FIG. 9 is a flow diagram of a method of efficient reporting of position measurements taken by a UE in a wireless communication network, according to an embodiment.

FIG. 10 is a flow diagram of a method of enabling efficient reporting of position measurements taken by a UE in a wireless communication network, according to an embodiment.

FIG. 11 is a block diagram of an embodiment of a UE, which can be utilized in embodiments as described herein.

FIG. 12 is a block diagram of an embodiment of a TRP, which can be utilized in embodiments as described herein.

FIG. 13 is a block diagram of an embodiment of a computer system, which can be utilized in embodiments as described herein.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

Qualcomm Ref. No. 2103112

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal.

As noted, the position determination of a user equipment (UE) often uses multiple measurements, involving multiple reference signals. And each reference signal may be identified uniquely by both the network and UE. Reference signals are typically part of a large hierarchical structure and may require a large amount of signaling overhead to uniquely identify. Embodiments provided herein address these and other issues by utilizing compression techniques in measurement data reporting provided to the location server, where traditional, inefficient forms of identifying information for each reference signal may be replaced with a unique identifier that sufficiently identifies each reference signal to both the UE and the network. Details regarding such embodiments are provided hereafter. First, however, a description of a wireless communication network environment is provided, for context.

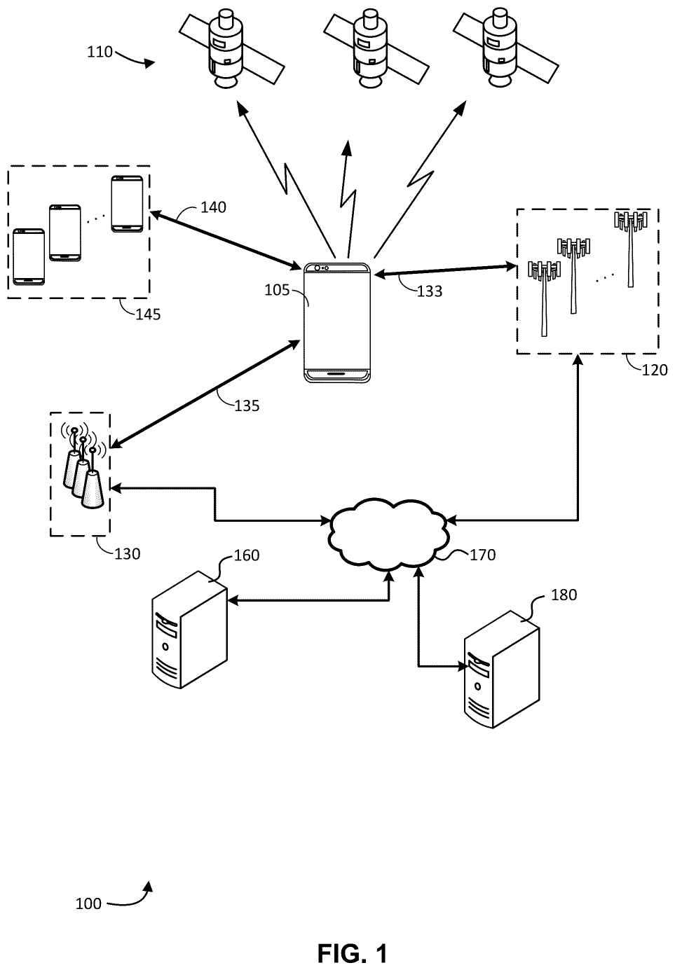

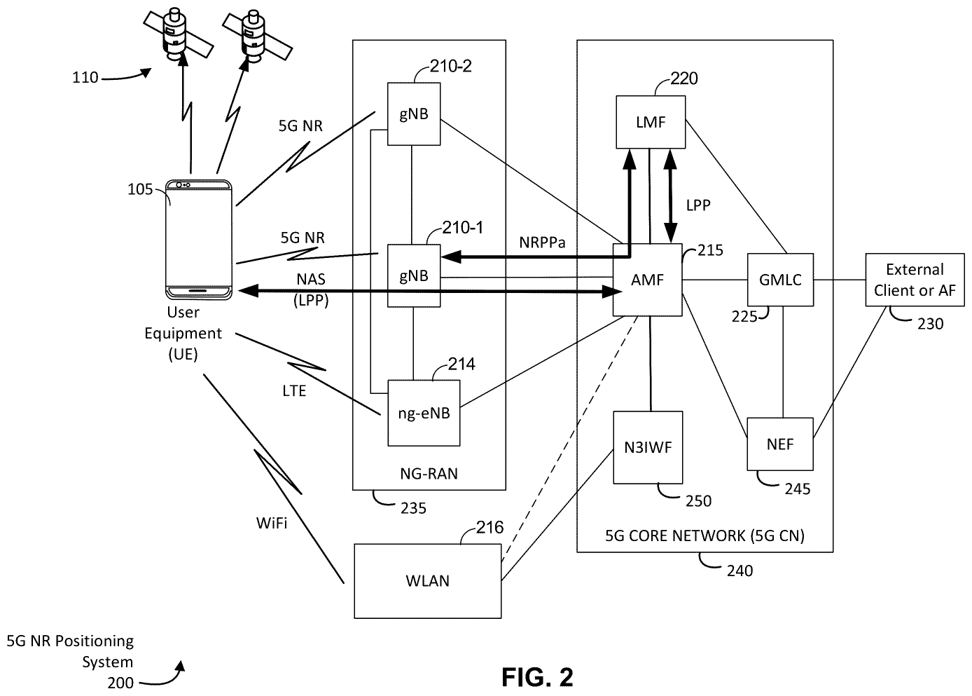

FIG. 1 is a simplified illustration of a positioning system 100 in which a UE 105, location server 160, and/or other components of the positioning system 100 can use the techniques provided herein for efficient reporting of position measurements taken by a UE 105, according to an embodiment. The techniques described herein may be implemented by one or more components of the positioning system 100. The positioning system 100 can include: a UE 105; one or more satellites 110 (also referred to as space vehicles (SVs)) for a Global Navigation Satellite System (GNSS) such as the Global Positioning System (GPS), GLONASS, Galileo or Beidou; base stations 120; access points (APs) 130; location server 160; network 170; and external client 180. Generally put, the positioning system 100 can estimate a location of the UE 105 based on RF signals received by and/or sent from the UE 105 and known locations of other components (e.g., GNSS satellites 110, base stations 120, APs 130) transmitting and/or receiving the RF signals. Additional details regarding particular location estimation techniques are discussed in more detail with regard to FIG. 2.

It should be noted that FIG. 1 provides only a generalized illustration of various components, any or all of which may be utilized as appropriate, and each of which may be duplicated as necessary. Specifically, although only one UE 105 is illustrated, it will be understood that many UEs (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network.

The base stations 120 and access points (APs) 130 are communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. An AP 130 may comprise a Wi-Fi AP or a Bluetooth® AP, for example. Thus, UE 105 can send and receive information with network-connected devices, such as location server 160, by accessing the network 170 via a base station 120 using a first communication link 133. Additionally or alternatively, because APs 130 also may be communicatively coupled with the network 170, UE 105 may communicate with network-connected and Internet-connected devices, including location server 160, using a second communication link 135.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

The location server 160 may comprise a server and/or other computing device configured to determine an estimated location of UE 105 and/or provide data (e.g., “assistance data”) to UE 105 to facilitate location measurement and/or location determination by UE 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for UE 105 based on subscription information for UE 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of UE 105 using a control plane (CP) location solution for LTE radio access by UE 105. The location server 160 may further comprise a Location Management Function (LMF) that supports location of UE 105 using a control plane (CP) location solution for NR or LTE radio access by UE 105.

In a CP location solution, signaling to control and manage the location of UE 105 may be exchanged between elements of network 170 and with UE 105 using existing network interfaces and protocols and as signaling from the perspective of network 170. In a UP location solution, signaling to control and manage the location of UE 105 may be exchanged between location server 160 and UE 105 as data (e.g. data transported using the Internet Protocol (IP) and/or Transmission Control Protocol (TCP)) from the perspective of network 170.

As previously noted (and discussed in more detail below), the estimated location of UE 105 may be based on measurements of RF signals sent from and/or received by the UE 105. In particular, these measurements can provide information regarding the relative distance and/or angle of the UE 105 from one or more components in the positioning system 100 (e.g., GNSS satellites 110, APs 130, base stations 120). The estimated location of the UE 105 can be estimated geometrically (e.g., using multiangulation and/or multilateration), based on the distance and/or angle measurements, along with known position of the one or more components.

Although terrestrial components such as APs 130 and base stations 120 may be fixed, embodiments are not so limited. Mobile components may be used. For example, in some embodiments, a location of the UE 105 may be estimated at least in part based on measurements of RF signals 140 communicated between the UE 105 and one or more other UEs 145, which may be mobile or fixed. When or more other UEs 145 are used in the position determination of a particular UE 105, the UE 105 for which the position is to be determined may be referred to as the “target UE,” and each of the one or more other UEs 145 used may be referred to as an “anchor UE.” For position determination of a target UE, the respective positions of the one or more anchor UEs may be known and/or jointly determined with the target UE. Direct communication between the one or more other UEs 145 and UE 105 may comprise sidelink and/or similar Device-to-Device (D2D) communication technologies. Sidelink, which is defined by 3GPP, is a form of D2D communication under the cellular-based LTE and NR standards.

An estimated location of UE 105 can be used in a variety of applications—e.g. to assist direction finding or navigation for a user of UE 105 or to assist another user (e.g. associated with external client 180) to locate UE 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of UE 105 may comprise an absolute location of UE 105 (e.g. a latitude and longitude and possibly altitude) or a relative location of UE 105 (e.g. a location expressed as distances north or south, east or west and possibly above or below some other known fixed location or some other location such as a location for UE 105 at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which UE 105 is expected to be located with some level of confidence (e.g. 95% confidence).

The external client 180 may be a web server or remote application that may have some association with UE 105 (e.g. may be accessed by a user of UE 105) or may be a server, application, or computer system providing a location service to some other user or users which may include obtaining and providing the location of UE 105 (e.g. to enable a service such as friend or relative finder, asset tracking or child or pet location). Additionally or alternatively, the external client 180 may obtain and provide the location of UE 105 to an emergency services provider, government agency, etc.

As previously noted, the example positioning system 100 can be implemented using a wireless communication network, such as an LTE-based or 5G NR-based network. FIG. 2 shows a diagram of a 5G NR positioning system 200, illustrating an embodiment of a positioning system (e.g., positioning system 100) implementing 5G NR. The 5G NR positioning system 200 may be configured to determine the location of a UE 105 by using access nodes 210, 214, 216 (which may correspond with base stations 120 and access points 130 of FIG. 1) and (optionally) an LMF 220 (which may correspond with location server 160) to implement one or more positioning methods. Here, the 5G NR positioning system 200 comprises a UE 105, and components of a 5G NR network comprising a Next Generation (NG) Radio Access Network (RAN) (NG-RAN) 235 and a 5G Core Network (5G CN) 240. A 5G network may also be referred to as an NR network; NG-RAN 235 may be referred to as a 5G RAN or as an NR RAN; and 5G CN 240 may be referred to as an NG Core network. The 5G NR positioning system 200 may further utilize information from GNSS satellites 110 from a GNSS system like Global Positioning System (GPS) or similar system (e.g. GLONASS, Galileo, Beidou, Indian Regional Navigational Satellite System (IRNSS). Additional components of the 5G NR positioning system 200 are described below. The 5G NR positioning system 200 may include additional or alternative components.

It should be noted that FIG. 2 provides only a generalized illustration of various components, any or all of which may be utilized as appropriate, and each of which may be duplicated or omitted as necessary. Specifically, although only one UE 105 is illustrated, it will be understood that many UEs (e.g., hundreds, thousands, millions, etc.) may utilize the 5G NR positioning system 200. Similarly, the 5G NR positioning system 200 may include a larger (or smaller) number of GNSS satellites 110, gNBs 210, ng-eNBs 214, Wireless Local Area Networks (WLANs) 216, Access and mobility Management Functions (AMF)s 215, external clients 230, and/or other components. The illustrated connections that connect the various components in the 5G NR positioning system 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 105 may comprise and/or be referred to as a device, a mobile device, a wireless device, a mobile terminal, a terminal, a mobile station (MS), a Secure User Plane Location (SUPL)—Enabled Terminal (SET), or by some other name. Moreover, UE 105 may correspond to a cellphone, smartphone, laptop, tablet, personal data assistant (PDA), tracking device, navigation device, Internet of Things (IoT) device, or some other portable or moveable device. Typically, though not necessarily, the UE 105 may support wireless communication using one or more Radio Access Technologies (RATs) such as using GSM, CDMA, W-CDMA, LTE, High Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 105 may also support wireless communication using a WLAN 216 which (like the one or more RATs, and as previously noted with respect to FIG. 1) may connect to other networks, such as the Internet. The use of one or more of these RATs may allow the UE 105 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 105 (e.g., via the GMLC 225). The external client 230 of FIG. 2 may correspond to external client 180 of FIG. 1, as implemented in or communicatively coupled with a 5G NR network.

The UE 105 may include a single entity or may include multiple entities, such as in a personal area network where a user may employ audio, video and/or data I/O devices, and/or body sensors and a separate wireline or wireless modem. An estimate of a location of the UE 105 may be referred to as a location, location estimate, location fix, fix, position, position estimate, or position fix, and may be geodetic, thus providing location coordinates for the UE 105 (e.g., latitude and longitude), which may or may not include an altitude component (e.g., height above sea level, height above or depth below ground level, floor level or basement level). Alternatively, a location of the UE 105 may be expressed as a civic location (e.g., as a postal address or the designation of some point or small area in a building such as a particular room or floor). A location of the UE 105 may also be expressed as an area or volume (defined either geodetically or in civic form) within which the UE 105 is expected to be located with some probability or confidence level (e.g., 67%, 95%, etc.). A location of the UE 105 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations 120 in FIG. 1 and may include NR NodeB (gNB) 210-1 and 210-2 (collectively and generically referred to herein as gNBs 210). Pairs of gNBs 210 in NG-RAN 235 may be connected to one another (e.g., directly as shown in FIG. 2 or indirectly via other gNBs 210). Access to the 5G network is provided to UE 105 via wireless communication between the UE 105 and one or more of the gNBs 210, which may provide wireless communications access to the 5G CN 240 on behalf of the UE 105 using 5G NR. 5G NR radio access may also be referred to as NR radio access or as 5G radio access. In FIG. 2, the serving gNB for UE 105 is assumed to be gNB 210-1, although other gNBs (e.g. gNB 210-2) may act as a serving gNB if UE 105 moves to another location or may act as a secondary gNB to provide additional throughput and bandwidth to UE 105.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235—e.g. directly or indirectly via other gNBs 210 and/or other ng-eNBs. An ng-eNB 214 may provide LTE wireless access and/or evolved LTE (eLTE) wireless access to UE 105. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 105 but may not receive signals from UE 105 or from other UEs. It is noted that while only one ng-eNB 214 is shown in FIG. 2, some embodiments may include multiple ng-eNBs 214. Base stations 210, 214 may communicate directly with one another via an Xn communication interface. Additionally or alternatively, base stations 210, 214 may communicate directly or indirectly with other components of the 5G NR positioning system 200, such as the LMF 220 and AMF 215.

5G NR positioning system 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 105 and may comprise one or more Wi-Fi APs (e.g., APs 130 of FIG. 1). Here, the N3IWF 250 may connect to other elements in the 5G CN 240 such as AMF 215. In some embodiments, WLAN 216 may support another RAT such as Bluetooth. The N3IWF 250 may provide support for secure access by UE 105 to other elements in 5G CN 240 and/or may support interworking of one or more protocols used by WLAN 216 and UE 105 to one or more protocols used by other elements of 5G CN 240 such as AMF 215. For example, N3IWF 250 may support IPSec tunnel establishment with UE 105, termination of IKEv2/IPSec protocols with UE 105, termination of N2 and N3 interfaces to 5G CN 240 for control plane and user plane, respectively, relaying of uplink (UL) and downlink (DL) control plane Non-Access Stratum (NAS) signaling between UE 105 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 105 and the AMF 215. This can include gNBs 210, ng-eNB 214, WLAN 216, and/or other types of cellular base stations. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214 or WLAN 216.

In some embodiments, an access node, such as a gNB 210, ng-eNB 214, or WLAN 216 (alone or in combination with other components of the 5G NR positioning system 200), may be configured to, in response to receiving a request for location information from the LMF 220, obtain location measurements of uplink (UL) signals received from the UE 105) and/or obtain downlink (DL) location measurements from the UE 105 that were obtained by UE 105 for DL signals received by UE 105 from one or more access nodes. As noted, while FIG. 2 depicts access nodes 210, 214, and 216 configured to communicate according to 5G NR, LTE, and Wi-Fi communication protocols, respectively, access nodes configured to communicate according to other communication protocols may be used, such as, for example, a Node B using a WCDMA protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 105, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5GCN 240 in FIG. 2. The methods and techniques described herein for obtaining a civic location for UE 105 may be applicable to such other networks.

The gNBs 210 and ng-eNB 214 can communicate with an AMF 215, which, for positioning functionality, communicates with an LMF 220. The AMF 215 may support mobility of the UE 105, including cell change and handover of UE 105 from an access node 210, 214, or 216 of a first RAT to an access node 210, 214, or 216 of a second RAT. The AMF 215 may also participate in supporting a signaling connection to the UE 105 and possibly data and voice bearers for the UE 105. The LMF 220 may support positioning of the UE 105 using a CP location solution when UE 105 accesses the NG-RAN 235 or WLAN 216 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Real Time Kinematic (RTK), Precise Point Positioning (PPP), Differential GNSS (DGNSS), Enhance Cell ID (ECID), angle of arrival (AOA), angle of departure (AOD), WLAN positioning, round trip signal propagation delay (RTT), multi-cell RTT, and/or other positioning procedures and methods. The LMF 220 may also process location service requests for the UE 105, e.g., received from the AMF 215 or from the GMLC 225. The LMF 220 may be connected to AMF 215 and/or to GMLC 225. In some embodiments, a network such as 5GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 105's location) may be performed at the UE 105 (e.g., by measuring downlink PRS (DL-PRS) signals transmitted by wireless nodes such as gNBs 210, ng-eNB 214 and/or WLAN 216, and/or using assistance data provided to the UE 105, e.g., by LMF 220).

The Gateway Mobile Location Center (GMLC) 225 may support a location request for the UE 105 received from an external client 230 and may forward such a location request to the AMF 215 for forwarding by the AMF 215 to the LMF 220. A location response from the LMF 220 (e.g., containing a location estimate for the UE 105) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 105 to the external client 230, which may then be referred to as an Access Function (AF) and may enable secure provision of information from external client 230 to 5GCN 240. NEF 245 may be connected to AMF 215 and/or to GMLC 225 for the purposes of obtaining a location (e.g. a civic location) of UE 105 and providing the location to external client 230.

As further illustrated in FIG. 2, the LMF 220 may communicate with the gNBs 210 and/or with the ng-eNB 214 using an NR Positioning Protocol A (NRPPa) as defined in 3GPP Technical Specification (TS) 38.445. NRPPa messages may be transferred between a gNB 210 and the LMF 220, and/or between an ng-eNB 214 and the LMF 220, via the AMF 215. As further illustrated in FIG. 2, LMF 220 and UE 105 may communicate using an LTE Positioning Protocol (LPP) as defined in 3GPP TS 37.355. Here, LPP messages may be transferred between the UE 105 and the LMF 220 via the AMF 215 and a serving gNB 210-1 or serving ng-eNB 214 for UE 105. For example, LPP messages may be transferred between the LMF 220 and the AMF 215 using messages for service-based operations (e.g., based on the Hypertext Transfer Protocol (HTTP)) and may be transferred between the AMF 215 and the UE 105 using a 5G NAS protocol. The LPP protocol may be used to support positioning of UE 105 using UE assisted and/or UE based position methods such as A-GNSS, RTK, TDOA, multi-cell RTT, AOD, and/or ECID. The NRPPa protocol may be used to support positioning of UE 105 using network based position methods such as ECID, AOA, uplink TDOA (UL-TDOA) and/or may be used by LMF 220 to obtain location related information from gNBs 210 and/or ng-eNB 214, such as parameters defining DL-PRS transmission from gNBs 210 and/or ng-eNB 214.

In the case of UE 105 access to WLAN 216, LMF 220 may use NRPPa and/or LPP to obtain a location of UE 105 in a similar manner to that just described for UE 105 access to a gNB 210 or ng-eNB 214. Thus, NRPPa messages may be transferred between a WLAN 216 and the LMF 220, via the AMF 215 and N3IWF 250 to support network-based positioning of UE 105 and/or transfer of other location information from WLAN 216 to LMF 220. Alternatively, NRPPa messages may be transferred between N3IWF 250 and the LMF 220, via the AMF 215, to support network-based positioning of UE 105 based on location related information and/or location measurements known to or accessible to N3IWF 250 and transferred from N3IWF 250 to LMF 220 using NRPPa. Similarly, LPP and/or LPP messages may be transferred between the UE 105 and the LMF 220 via the AMF 215, N3IWF 250, and serving WLAN 216 for UE 105 to support UE assisted or UE based positioning of UE 105 by LMF 220.

In a 5G NR positioning system 200, positioning methods can be categorized as being “UE assisted” or “UE based.” This may depend on where the request for determining the position of the UE 105 originated. If, for example, the request originated at the UE (e.g., from an application, or “app,” executed by the UE), the positioning method may be categorized as being UE based. If, on the other hand, the request originates from an external client or AF 230, LMF 220, or other device or service within the 5G network, the positioning method may be categorized as being UE assisted (or “network-based”).

With a UE-assisted position method, UE 105 may obtain location measurements and send the measurements to a location server (e.g., LMF 220) for computation of a location estimate for UE 105. For RAT-dependent position methods location measurements may include one or more of a Received Signal Strength Indicator (RSSI), Round Trip signal propagation Time (RTT), Reference Signal Received Power (RSRP), Reference Signal Received Quality (RSRQ), Reference Signal Time Difference (RSTD), Time of Arrival (TOA), AOA, Receive Time-Transmission Time Difference (Rx-Tx), Differential AOA (DAOA), AOD, or Timing Advance (TA) for gNBs 210, ng-eNB 214, and/or one or more access points for WLAN 216. Additionally or alternatively, similar measurements may be made of sidelink signals transmitted by other UEs, which may serve as anchor points for positioning of the UE 105 if the positions of the other UEs are known. The location measurements may also or instead include measurements for RAT-independent positioning methods such as GNSS (e.g., GNSS pseudorange, GNSS code phase, and/or GNSS carrier phase for GNSS satellites 110), WLAN, etc.

With a UE-based position method, UE 105 may obtain location measurements (e.g., which may be the same as or similar to location measurements for a UE assisted position method) and may further compute a location of UE 105 (e.g., with the help of assistance data received from a location server such as LMF 220, an SLP, or broadcast by gNBs 210, ng-eNB 214, or WLAN 216).

With a network based position method, one or more base stations (e.g., gNBs 210 and/or ng-eNB 214), one or more APs (e.g., in WLAN 216), or N3IWF 250 may obtain location measurements (e.g., measurements of RSSI, RTT, RSRP, RSRQ, AOA, or TOA) for signals transmitted by UE 105, and/or may receive measurements obtained by UE 105 or by an AP in WLAN 216 in the case of N3IWF 250, and may send the measurements to a location server (e.g., LMF 220) for computation of a location estimate for UE 105.

Positioning of the UE 105 also may be categorized as UL, DL, or DL-UL based, depending on the types of signals used for positioning. If, for example, positioning is based solely on signals received at the UE 105 (e.g., from a base station or other UE), the positioning may be categorized as DL based. On the other hand, if positioning is based solely on signals transmitted by the UE 105 (which may be received by a base station or other UE, for example), the positioning may be categorized as UL based. Positioning that is DL-UL based includes positioning, such as RTT-based positioning, that is based on signals that are both transmitted and received by the UE 105. Sidelink (SL)—assisted positioning comprises signals communicated between the UE 105 and one or more other UEs. According to some embodiments, UL, DL, or DL-UL positioning as described herein may be capable of using SL signaling as a complement or replacement of SL, DL, or DL-UL signaling.

Depending on the type of positioning (e.g., UL, DL, or DL-UL based) the types of reference signals used can vary. For DL-based positioning, for example, these signals may comprise PRS (e.g., DL-PRS transmitted by base stations or SL-PRS transmitted by other UEs), which can be used for TDOA, AOD, and RTT measurements. Other reference signals that can be used for positioning (UL, DL, or DL-UL) may include Sounding Reference Signal (SRS), Channel State Information Reference Signal (CSI-RS), synchronization signals (e.g., synchronization signal block (SSB) Synchronizations Signal (SS)), Physical Uplink Control Channel (PUCCH), Physical Uplink Shared Channel (PUSCH), Physical Sidelink Shared Channel (PSSCH), Demodulation Reference Signal (DMRS), etc. Moreover, reference signals may be transmitted in a Tx beam and/or received in an Rx beam (e.g., using beamforming techniques), which may impact angular measurements, such as AOD and/or AOA.

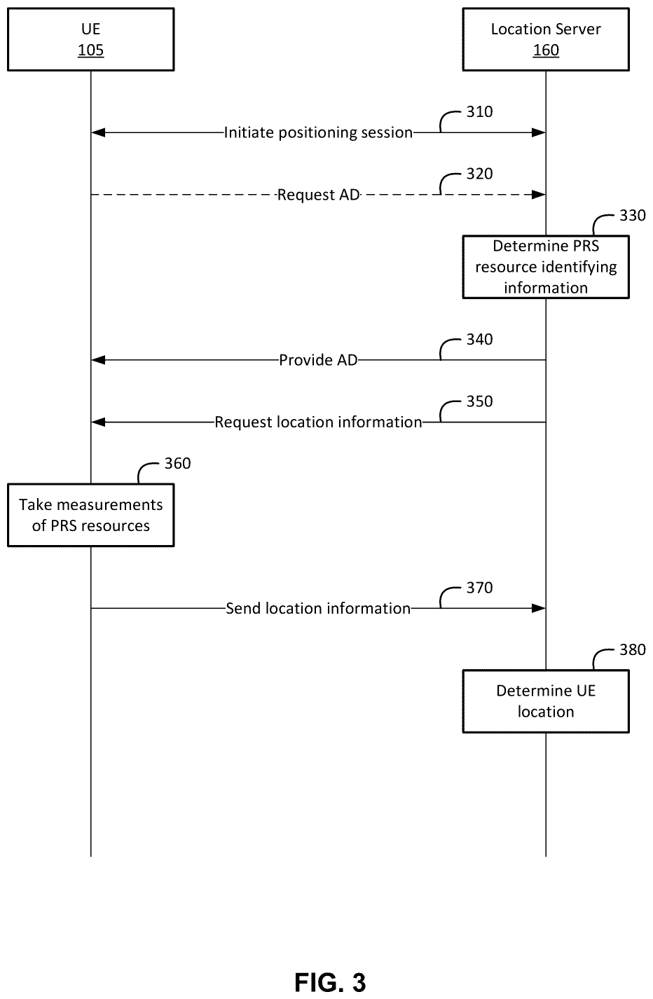

FIG. 3 is a call-flow diagram that illustrates a basic exchange of assistance data (AD) and reporting between a UE 105 and location server 160 (e.g., LMF 220) used to determine the position of the UE 105. This can represent, for example, an LPP positioning session between the UE 105 and location server 160, although embodiments are not necessarily limited to LPP positioning. Further, although FIG. 3 illustrates UE —assisted positioning of the UE 105 in which the location server 160 determines the location of the UE, embodiments may not be so limited.

Here, the positioning session between the UE 105 and location server 160 is initiated, as indicated at arrow 310. Based on the type of positioning (e.g., UE-assisted or UE-based) the positioning session may be initiated by the UE 105 (e.g., in the case of UE-based) or location server 160 (e.g., in the case of UE-assisted). Preliminary information such as capabilities of the UE 105 and/or location server 160 may be exchanged. The initiation of the positioning session at arrow 310 may further indicate the types of positioning to be performed (e.g., based on capabilities). This may include positioning types for which measurement information taken by the UE 105 is to be reported back to the location server 160. Such positioning types can include, for example, multi-RTT positioning, DL-AoD positioning, DL-TDOA positioning, Enhanced Cell ID (E-CID) positioning, and/or UL positioning.

For instances in which the UE 105 may need configuration information regarding reference signals (e.g., PRS resources), the UE 105 optionally may request assistance data (AD), as indicated by dashed arrow 320. Whether AD is explicitly requested or not, the location server 160 may determine the AD to provide the UE 105. This determination can include, in part, a determination of PRS resource identifying information 330. Additional details regarding this identifying information are provided hereafter. The AD with the PRS resource information is then provided by the location server 160 to the UE 105, as indicated at arrow 340.

Location server 160 may then request location information, as indicated at arrow 350. Among other things, the location information may include measurements taken of PRS resources identified in the AD, which are taken by the UE as indicated at block 360. This measurement data, along with identifying information regarding the PRS resources from which measurements were taken, are included in the location information sent from the UE 105 to the location server 160, as indicated at arrow 370. Location information comprising measurement data and corresponding identifying information is referred to herein as a “measurement report.” Using this information, the location server 160 then determines the UE location, as indicated at block 380.

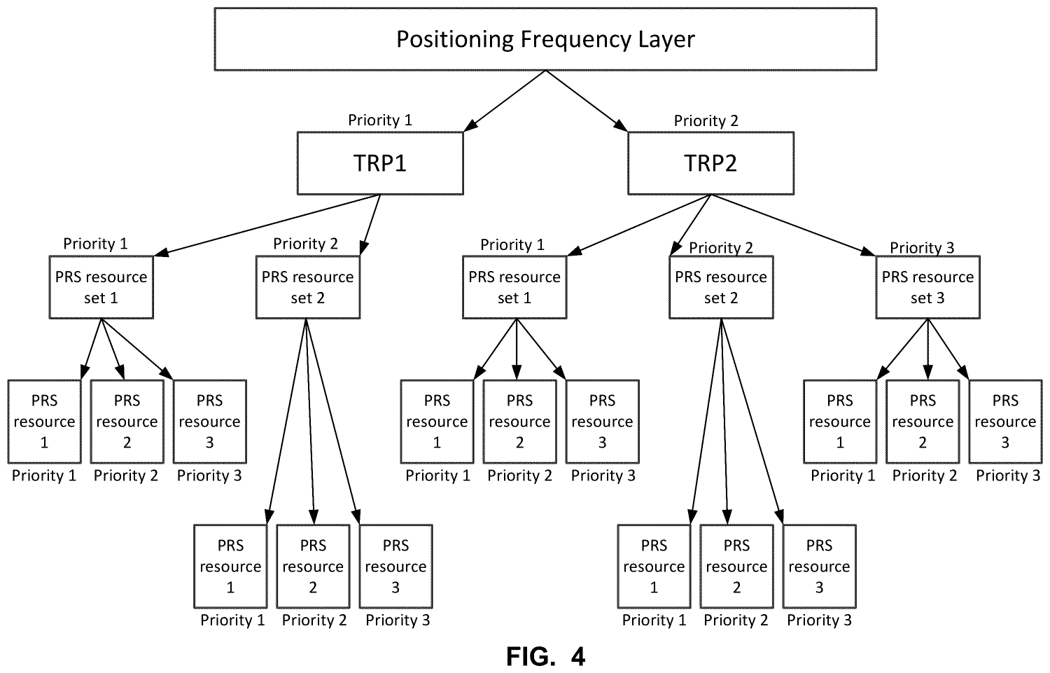

As noted, identifying information for reference signals (PRS resources) can involve a large amount of signaling overhead. This is due, in part, because of the hierarchical structure of PRS resources. The structure is illustrated in more detail in FIG. 4.

FIG. 4 as a diagram of a hierarchical structure of how PRS resources and PRS resource sets may be used by different TRPs of a given Positioning Frequency Layer (PFL), as defined in 5G NR. In brief, a UE may have certain capabilities with regard to being able to aggregate reference signals transmitted by one or more TRPs in a PFL. The use of multiple PRS resources in multiple PFLs can effectively increase the bandwidth of the reference signals for a measurement taken to determine the location of the UE. More particularly, this increase in bandwidth comes by aggregating the PRS resources (e.g., processing the reference signals jointly in the signal domain). The UE's ability to aggregate or transmit these reference signals may be limited by channel spacing, timing offset, phase offset (or phase misalignment), frequency error, power imbalance, and other such factors between reference signals of different PFLs.

With respect to a network (Uu) interface, a UE 105 can be configured by a location server 160 with one or more PRS resource sets from each of one or more TRPs. Each PRS resource set includes K≥1 PRS resource(s), which may correspond to a Tx beam of the TRP. A PRS PFL is defined as a collection of PRS resource sets which have the same subcarrier spacing (SCS) and cyclic prefix (CP) type, the same value of PRS bandwidth, the same center frequency, and the same value of comb size. In current iterations of the NR standard, a UE 105 can be configured with up to four DL PRS PFLs.

NR has multiple frequency bands across different frequency ranges (e.g., Frequency Range 1 (FR1) and Frequency Range 2 (FR2)). PFLs may be on the same band or different bands. Additionally, as illustrated in FIG. 4, multiple TRPs (e.g., TRP1 and TRP2) may be on the same PFL. Each TRP can have multiple PRS resource sets, each with one or more PRS resources. In the example PFL illustrated in FIG. 4, TRP1 has two PRS resource sets, and TRP2 has three PRS resource sets. Each PRS resource set has three PRS resources, totaling in 15 PRS resources. (It can be noted, however, that the number of TRPs, PRS resource sets, and PRS resources, can vary from the number illustrated in the example in FIG. 4. For example, different PRS resource sets may have different numbers of PRS resources.) A PRS “sequence” comprises the PRS resources used in a positioning session of a UE 105 to determine the location of the UE 105. Each sequence may be specific to the UE 105, although different PRS resources within the sequence may be broadcast and measured by multiple UEs at a time.

A location server 160 can configure a UE 105 to measure the PRS resources, resulting in measurements that can be reported by the UE 105 to the location server 160 to determine the location of the UE 105. This configuration, which can include information such as timing, frequency, etc. for each PRS resource, may be included in the AD provided from the location server 160 to the UE 105. To do so, the AD includes identifying information for each PRS resource. Further, when the UE 105 provides measurement data for each PRS resource measured (e.g., in the location information, or measurement report, sent at arrow 370), the UE 105 includes the identifying information for each PRS resource together with the measurement data. As previously noted, this identifying information can consume a large amount of signaling overhead. Again, this is due, in part, to the hierarchy illustrated in FIG. 4.

In current versions of the applicable NR specification, this identifying information can include six information elements (IEs). These IEs include an identifier of a TRP transmitting the PRS resource (e.g., “dl-PRS-ID-r16”), an optional physical cell ID of the TRP (“nr-PhysCellID-r16”), a global cell ID of the TRP (“nr-CellGlobalID-r16”), an Absolute Radio-Frequency Channel Number (ARFCN) or bandwidth ID (“nr-ARFCN-r16”), a resource ID (“nr-DL-PRS-ResourceID-r16”), and a resource set ID (“nr-DL-PRS-ResourceSetID-r16”). This information is included to cover all types of use cases to ensure accurate identification of each PRS resource. However, it results in an inefficient means of communicating the identification information. Table 1 below provides additional detail.

TABLE 1
Identification Information Detail

| Information Element (IE) | Description | Number of Bits |
|---|---|---|
| dl-PRS-ID-r16 | INTEGER (0..255) | 8 |
| nr-PhysCellID-r16 | INTEGER (0..1007) | 10 |
| nr-CellGlobalID-r16 | NCGI-r15 ::= SEQUENCE { | 42 |
| | mcc-r15 SEQUENCE (SIZE (3)) OF | |
| | INTEGER (0..9), | |
| | mnc-r15 SEQUENCE (SIZE (2..3)) OF | |
| | INTEGER (0..9), | |
| | nr-cellidentity-r15 BIT STRING (SIZE | |
| | (36)) } | |
| nr-ARFCN-r16 | INTEGER (0..3279165) | 22 |
| nr-DL-PRS-ResourceID-r16 | nrMaxResourceIDs-r16 = 64 | 6 |
| nr-DL-PRS-ResourceSetID-r16 | INTEGER (0..nrMaxNumDL-PRS- | 3 |
| | ResourceSetsPerTRP-1-r16) | |
| | nrMaxNumDL-PRS- | |
| | ResourceSetsPerTRP-1-r16 = 7 | |

As shown in Table 1, these IEs can vary from 3 to 42 bits in length, totaling up to 91 bits. However, the purpose of these IEs is to uniquely identify PRS resources in a sequence, the maximum possible number of which is the product of the maximum number of TRPs, the maximum number of resource sets per TRP, and the maximum number of PRS resources per resource set: 256*7*64=114688. The required number of bits to represent this maximum number of possible PRS resource identifiers in a sequence is therefore log2(114688), or 17 bits. This is far less than the up to 91 bits currently used and illustrative of the large overhead and inefficiency of communicating identification information in this manner. Moreover, in most scenarios, only a small portion of the maximum number of PRS resources are used in a PRS sequence. And thus, fewer than 17 bits are needed in most positioning sessions.

To address these and other issues, embodiments herein leverage information, such as priority information, inherently conveyed in the hierarchical structure of a positioning frequency layer (e.g., FIG. 4) to determine a sequence identifier unique to each PRS resource of a sequence. This unique sequence number can then be used in the reporting of measurement data by the UE (or other reporting device, as discussed hereafter) to the location server. As such, embodiments herein effectively provide means for compressing identification information included in position measurement reporting.

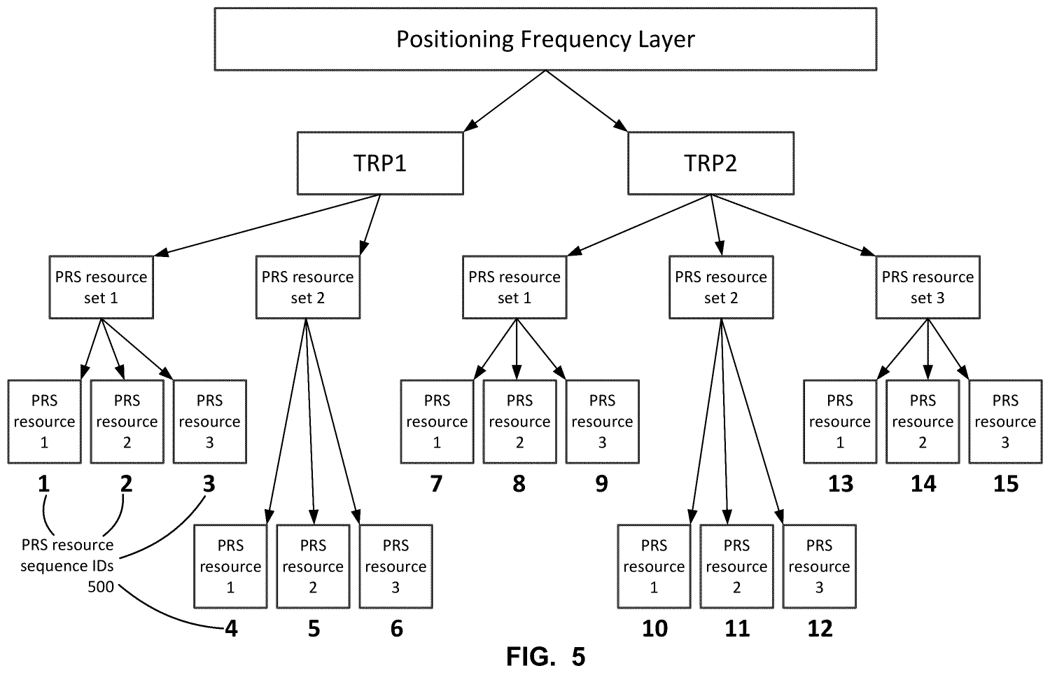

Returning to FIG. 4, the hierarchical structure is conveyed in the AD provided by the location server to the UE an includes an inherent priority of PRS resources. That is, PFLs, TRPs, resource sets, and PRS resources are provided in the AD in a decreasing order of measurement priority. And thus, the first PRS resource of the first PRS resource set of the first TRP in the first positioning layer (e.g., the left-most PRS resource in FIG. 4) will have the highest priority, and the last PRS resource of the last PRS resource set of the last TRP in the last positioning layer (e.g., the right-most PRS resource in FIG. 4) will have the lowest priority. The priority of PRS resources in a sequence, although not explicit in the AD, is therefore known by both location server and UE. As noted, embodiments can leverage this inherent priority information to assign a unique PRS resource sequence identifier or ID to each PRS resource in a sequence. Example is illustrated in FIG. 5.

FIG. 5 is a diagram of the hierarchical structure of PRS resources in the example of FIG. 4, with assigned PRS resource sequence IDs 500, according to an embodiment. (To avoid clutter, only a portion of the PRS resource sequence IDs 500 have been labeled in FIG. 5.) Here, each PRS resource sequence ID 500 is simply an index number, with the highest-priority PRS resource given the lowest number, and the lowest-priority PRS resource given the highest number. (Depending on desired functionality, the lowest number may start at zero or one.) Alternative embodiments may use alternative techniques for determining unique sequence numbers for PRS resources in a positioning session based on PRS resource priority.

According to some embodiments, therefore, a UE (or other reporting device) providing measurement data for each PRS resource may therefore include the PRS resource sequence ID 500 of the respective PRS resource, rather than the various IEs in Table 1. In the example of FIG. 5, the PRS resource sequence IDs 500 range from 1-15, and therefore only 4 bits are needed to convey the unique PRS resource sequence ID 500 of each PRS resource.

According to some embodiments, the UE (or other reporting device) may additionally include length information indicative of the number of bits of the PRS resource sequence ID 500. This can be a sequence-specific number. Thus, in the example of FIG. 5 where the PRS resource sequence IDs 500 are 4 bits long, the length information may indicate this. Other sequences may have more or fewer PRS resources, and thus the lengths may vary for different positioning sessions. That said, alternative embodiments may have a standard, fixed length for PRS resource sequence IDs 500. In such embodiments, a separate length indicator may not be used.

It can be noted that the PRS resource sequence IDs 500 are unique to a UE and are valid during a positioning session. Different positioning sessions between the same UE 105 and location server 160 can result in reuse of PRS resource sequence IDs (e.g., a sequence or index number) unique to each respective positioning session. Additionally, a single PRS resource may be used by multiple UEs for different (simultaneous) positioning sessions, in which case the PRS resource may have a different PRS resource sequence ID for each positioning session.

It can be additionally noted that although embodiments described in relation for FIGS. 4 and 5 show how sequence identifiers PRS resource sequence IDs 500 may be derived from priority, embodiments are not so limited. Other algorithms for generating PRS resource sequence IDs 500, unique to each PRS resource in the sequence, may be used. These algorithms may use information conveyed in the AD (e.g., information included in the six IEs for each PRS resource) to determine a unique sequence ID for each PRS resource.

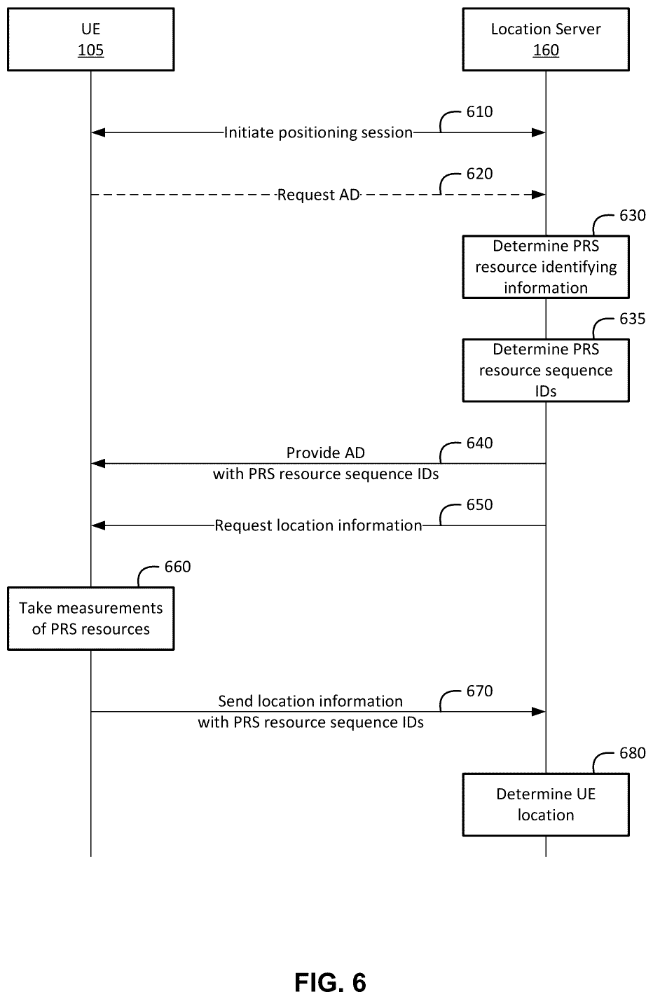

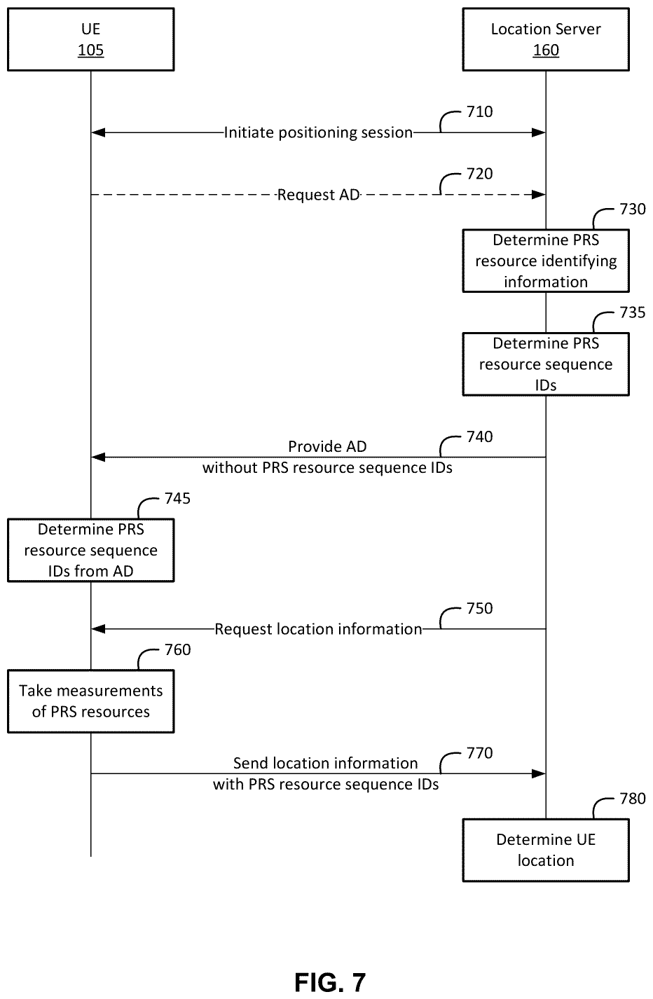

In practice, the use of PRS resource sequence IDs 500 may be implemented in different ways. FIGS. 6 and 7 are call-flow diagrams illustrating to such implementations.

FIG. 6 is a call-flow diagram that illustrates a first implementation in which PRS resource sequence ID information is included in the AD. Here, actions 610-680 generally echo corresponding actions 310-380 of FIG. 3, as previously described. Here, however, the location server 160 additionally determines PRS resource sequence IDs, shown at block 635, for each PRS resource included in the AD. The PRS resource sequence IDs are then included with the AD sent to the UE 105, shown by arrow 640. Subsequently, after the UE 105 has taken measurements of the PRS resources (at block 660), the UE includes the measurement data and PRS resource sequence ID for each PRS resource measured in the location information sent to the location server 160, shown by arrow 670. However, because each PRS resource sequence ID uniquely identifies each PRS resource, the UE 105 does not need to further include any of the additional PRS resource identifying information that would be necessary in traditional PRS measurement reports.

Although this implementation involves including additional information in the AD (e.g., a PRS resource sequence ID for each PRS resource), this implementation can still result in a large amount of savings an overhead over the course of a positioning session between the UE 105 and a location server. This is because the UE 105 can repeat steps 660 and 670 many times over the course of a positioning session, measuring many PRS resources in providing those measurements to the location server 160 without necessarily receiving additional AD from the location server 160.

FIG. 7 is a call-flow diagram that illustrates a second implementation in which PRS resource sequence ID information is separately determined by the location server 160 and UE 105. Here, actions 710-780 generally echo corresponding actions 610-680 of FIG. 6, as previously described. Here, however, although the location server 160 determines PRS resource sequence IDs (block 735), these IDs are omitted from the AD provided to the UE 105, shown by arrow 740. Rather than using the PRS resource sequence IDs included in the AD in the manner shown in FIG. 6, the UE 105 can instead determine PRS resource sequence IDs from the AD, as shown by block 745. The rest of the actions shown in FIG. 7 can then proceed in a manner similar to FIG. 6. As compared with the implementation of FIG. 6, the implementation in FIG. 7 requires slightly more resources from the UE 105 to determine the PRS resource sequence IDs. However, it results in additional overhead savings by omitting the PRS resource sequence IDs from the AD provided at arrow 740.

Alternative embodiments may employ variations to the processes illustrated in FIGS. 6 and 7 to accommodate different scenarios that may occur during the course of a positioning session between the location server 160 and UE 105. For example, according to some embodiments, PRS resource sequence IDs may be redetermined if there are changes to the PRS resources of a sequence during a positioning session. Additions and/or deletions can occur, for example, if the UE 105 changes location, which can impact the TRPs from which a UE 105 may measure PRS resources. More specifically, movement away from a first TRP may result in the UE 105 not being able to measure PRS resources of the first TRP, whereas movement toward a second TRP may result in the UE 105 being able to measure PRS resources of the second TRP, and so forth. In such instances, TRP is can be added to or removed from the AD by means of updates to the AD over the course of a positioning session. This may be conveyed to the UE 105, for example, via a Radio Resource Control (RRC) message. Further, because governing standards for RRC messages dictate when a UE 105 must implement an RRC command, it can be clear to both the UE 105 and location server 160 the time at which the UE 105 switches from previous AD to the new AD.

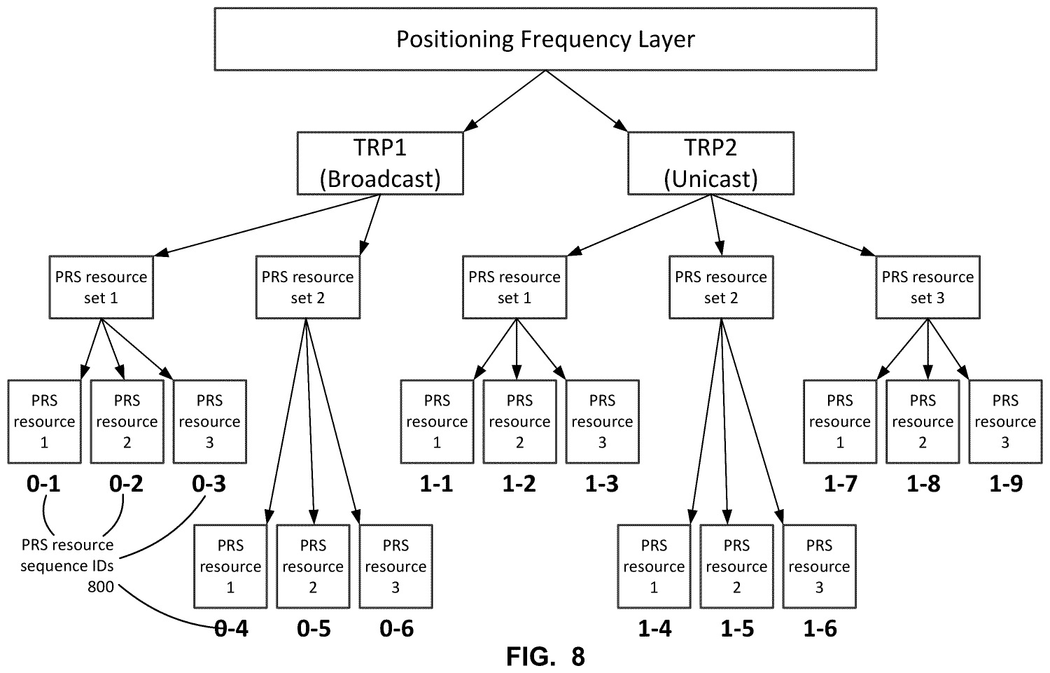

Additionally or alternatively, embodiments may implement features that help ensure common indexing between a UE 105 and location server 160 in certain situations in which the location server 160 may not be aware of the version of AD being used by the UE 105. This can occur, for example, in instances in which the UE 105 receives AD from a combination of broadcast and unicast AD, or in cases where the UE may utilize multiple versions of AD from different cells during the handover process between one cell to another. An example of this is illustrated in FIG. 8.

FIG. 8 is a diagram of the hierarchical structure of PRS resources similar to FIG. 5. Here, however, the PRS resource sequence IDs 800 distinguish between PRS resources received from broadcast AD (associated with TRP1) and PRS resources received from unicast AD (associated with TRP2). In this example, PRS resource sequence IDs 800 have a “0” or “1” prefix indicating whether the PRS resource was received from broadcast AD or unicast AD, respectively. In this way, the location server 160 can verify the source of the AD from which the PRS resource sequence IDs 800 were determined, based on the prefix of the PRS resource sequence IDs 800 included in the measurement report provided by the UE 105.

A similar solution can be used during a handover scenario in which the UE 105 moves from one cell to another. That is, a prefix can be added to indicate the cell (or TRP) from which AD is being used. In this case, a multi-bit prefix may be used to distinguish between a source cell (e.g., “10”) and a target cell (e.g., “11”).

As previously noted, a device providing measurement data to a location server 160 may not always comprise the UE 105 taking measurements. That is, in certain circumstances, a separate device may obtain measurement data taken by the UE 105 and report the measurement data to the location server. This can occur, for example, where a TRP (e.g., gNB) or SL UE (e.g., a separate UE communicatively connected via an SL connection with the UE 105) receives measurement data from the UE 105 and relays the measurement data to the location server 160. In such scenarios, the TRP or SL UE may therefore determine the PRS resource sequence IDs and provide the measurement data including the PRS resource sequence IDs as described herein above.

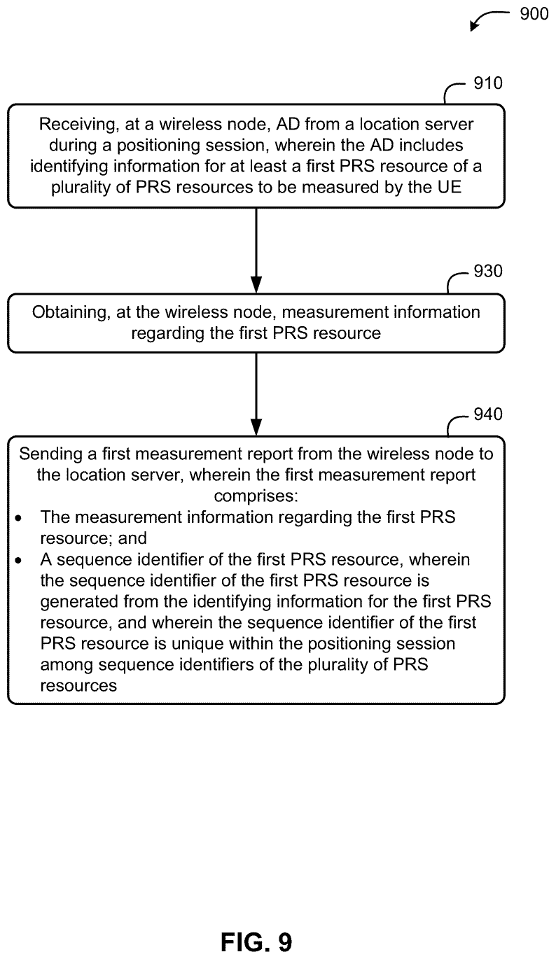

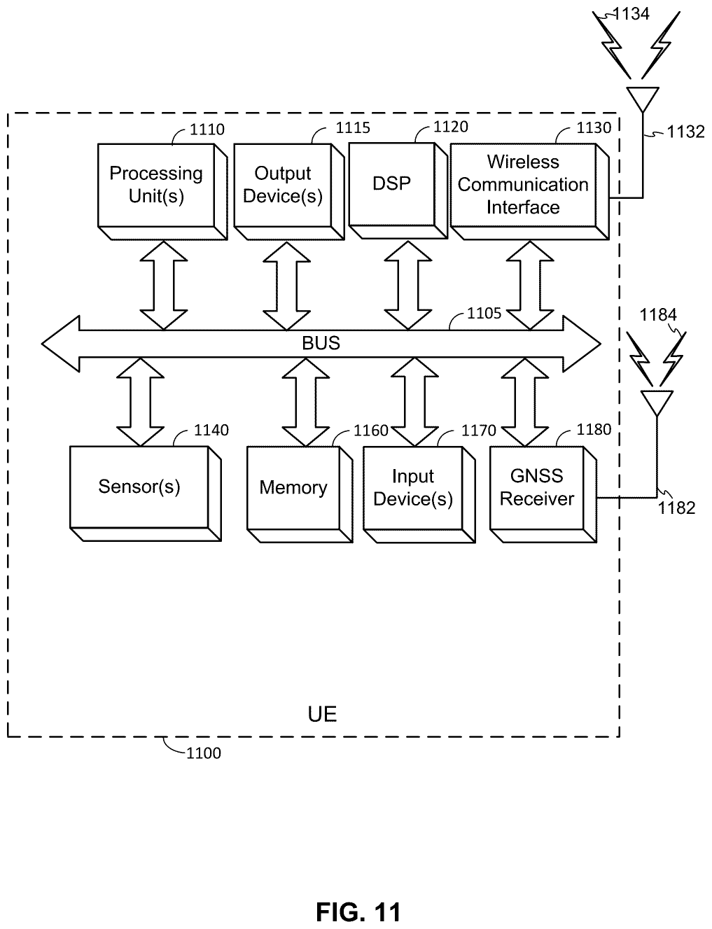

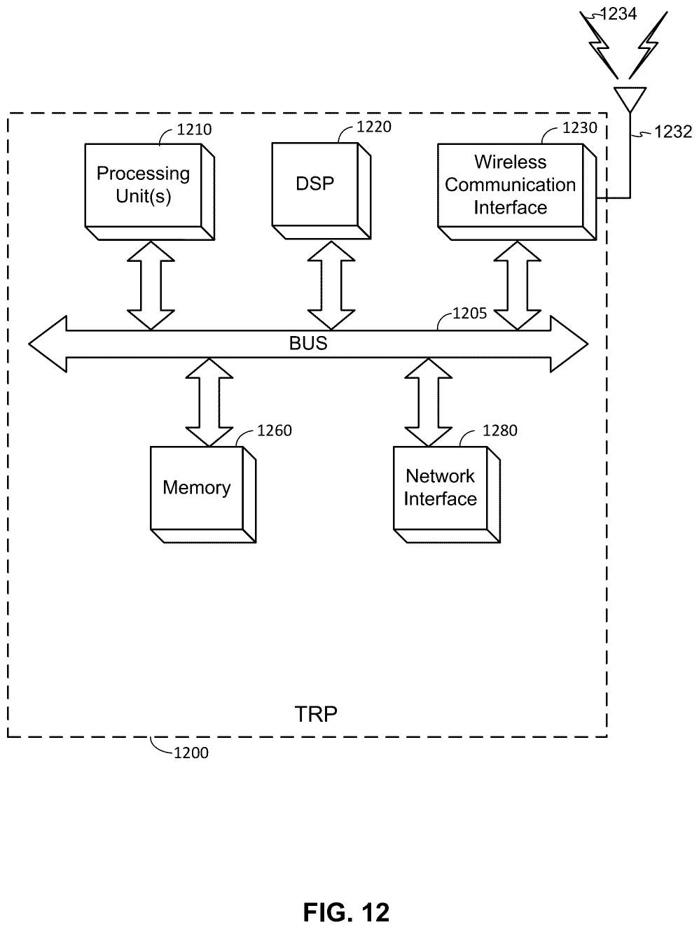

FIG. 9 is a flow diagram of a method 900 of efficient reporting of position measurements taken by a UE in a wireless communication network, according to an embodiment. In some aspects, the functionality of method 900 illustrates the functionality performed by the UE 105 as shown in the flow diagram in FIG. 7. One or more of the functions illustrated in the blocks of FIG. 9 can be performed by a wireless node comprising the UE itself, or a TRP or second UE (e.g., ASL UE) that receives measurement data from the UE. Thus, means for performing the functionality illustrated in one or more of the blocks shown in FIG. 9 may be performed by hardware and/or software components of a UE or TRP. Example components of a UE are illustrated in FIG. 11, and example components of a TRP are illustrated in FIG. 12, both of which are described in more detail below.

At block 910, the functionality comprises receiving, at a wireless node, AD from a location server during a positioning session, wherein the AD includes identifying information for at least a first PRS resource of a plurality of PRS resources to be measured by the UE during the positioning session. In some embodiments, the at least a first PRS resource may comprise a plurality of PRS resources, and the AD may include identifying information for each of the PRS resources. As previously noted, the identifying information included in the AD may comprise traditional identifying information for PRS resources, such as one or more of the IEs included in Table 1. In particular, the identifying information for the first PRS resource may comprise a PFL identifier, a TRP identifier, a physical cell identifier, an ARFCN identifier, a resource set identifier, or a resource identifier, or a combination thereof. Further, as also noted, the AD received by the wireless node may be unicast to the wireless node from the location server (e.g., via a serving TRP).

Means for performing functionality at block 910 may comprise, for example, a bus 1105, processing unit(s) 1110, digital signal processor (DSP) 1120, wireless communication interface 1130, memory 1160, and/or other components of a UE 1100 as illustrated in FIG. 11. Additionally or alternatively, means for performing functionality at block 910 may comprise, for example, a bus 1205, processing unit(s) 1210, DSP 1220, wireless communication interface 1230, memory 1260, network interface 1280, and/or other components of a UE 1200 as illustrated in FIG. 12.

At block 930, the functionality comprises obtaining, at the wireless node, measurement information regarding the first PRS resource. In embodiments in which the wireless node comprises the UE, obtaining measurement information may comprise taking one or more measurements of the first PRS resource. In embodiments in which the wireless node comprises a TRP or second UE, obtaining measurement information may comprise receiving the measurement information wirelessly from the UE.

Means for performing functionality at block 930 may comprise, for example, a bus 1105, processing unit(s) 1110, DSP 1120, wireless communication interface 1130, memory 1160, and/or other components of a UE 1100 as illustrated in FIG. 11. Additionally or alternatively, means for performing functionality at block 930 may comprise, for example, a bus 1205, processing unit(s) 1210, DSP 1220, wireless communication interface 1230, memory 1260, network interface 1280, and/or other components of a UE 1200 as illustrated in FIG. 12.

At block 940, the functionality comprises sending a first measurement report from the wireless node to the location server, wherein the first measurement report comprises (i) the measurement information regarding the first PRS resource, and (ii) a sequence identifier of the first PRS resource, wherein the sequence identifier of the first PRS resource is generated from the identifying information for the first PRS resource, and wherein the sequence identifier of the first PRS resource is unique within the positioning session among sequence identifiers of the plurality of PRS resources. As noted previously, sequence identifiers may be based on a priority of the PRS resources. Thus, according to some embodiments, the sequence identifier of the first PRS resource may be generated from the identifying information based on a priority of the first PRS resource determined from the identifying information. As previously described in relation to FIGS. 4, 5, and 8, priority information can be implied in hierarchical structure of the PRS resource sequence of a positioning session, where the hierarchical structure is described by the identifying information in the AD. From this, PRS resource sequence IDs (e.g., index numbers) can be designated for each PRS resource. As noted in FIG. 8 sequence identifiers may further include an indicator (e.g., in the form of a prefix having one or more bits) of whether the AD is received via unicast or broadcast, and/or whether the AD is received during a handover from a source TRP or target TRP. As previously indicated, measurement reports such as the first measurement report may be included in location information sent by the wireless device in response to a location information request from the location server. As shown in FIG. 7, because the location server can separately determine sequence identifiers, there may be no need for any additional identification information (e.g., IEs of Table 1) of the first PRS resource the first measurement report to identify the measurement information of the first PRS resource to the location server. Thus, any or all of this additional identification information may be omitted from the first measurement report. As previously described, length information of the sequence identifier may be included in the measurement report. As such, according to some embodiments of the method 900, the first measurement report further comprises an indication of a length of the sequence identifier of the first PRS resource. Means for performing functionality at block 940 may comprise, for example, a bus 1105, processing unit(s) 1110, DSP 1120, wireless communication interface 1130, memory 1160, and/or other components of a UE 1100 as illustrated in FIG. 11. Additionally or alternatively, means for performing functionality at block 940 may comprise, for example, a bus 1205, processing unit(s) 1210, DSP 1220, wireless communication interface 1230, memory 1260, network interface 1280, and/or other components of a UE 1200 as illustrated in FIG. 12.

As previously described, embodiments may accommodate changes to AD, such as addition and/or removal of PRS resources from a sequence of a positioning session. Embodiments may therefore further comprise receiving, at a wireless node, updated AD from a location server, wherein the updated AD adds a PRS resource to the plurality of PRS resources, removes a PRS resource from the plurality of PRS resources, or both. Such embodiments may further comprise obtaining measurement information regarding a second PRS resource, and sending a second measurement report to the location server, wherein the second measurement report comprises (i) the measurement information regarding the second PRS resource, and (ii) a sequence identifier of the second PRS resource, wherein the sequence identifier of the second PRS resource is generated from the updated AD.

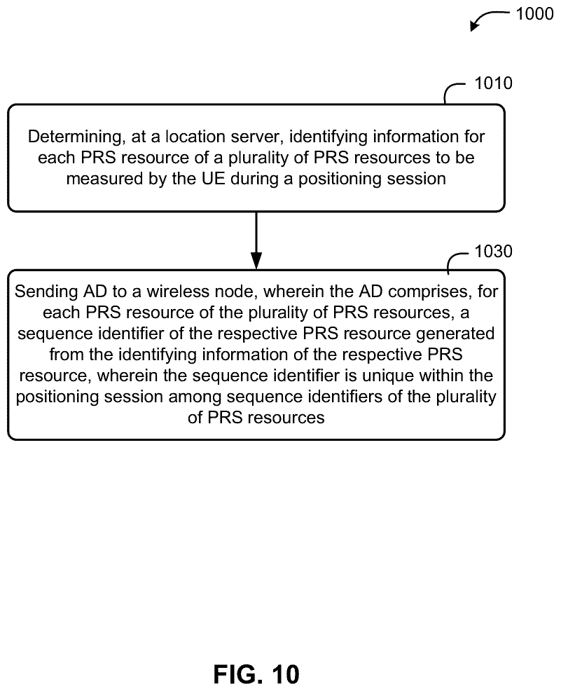

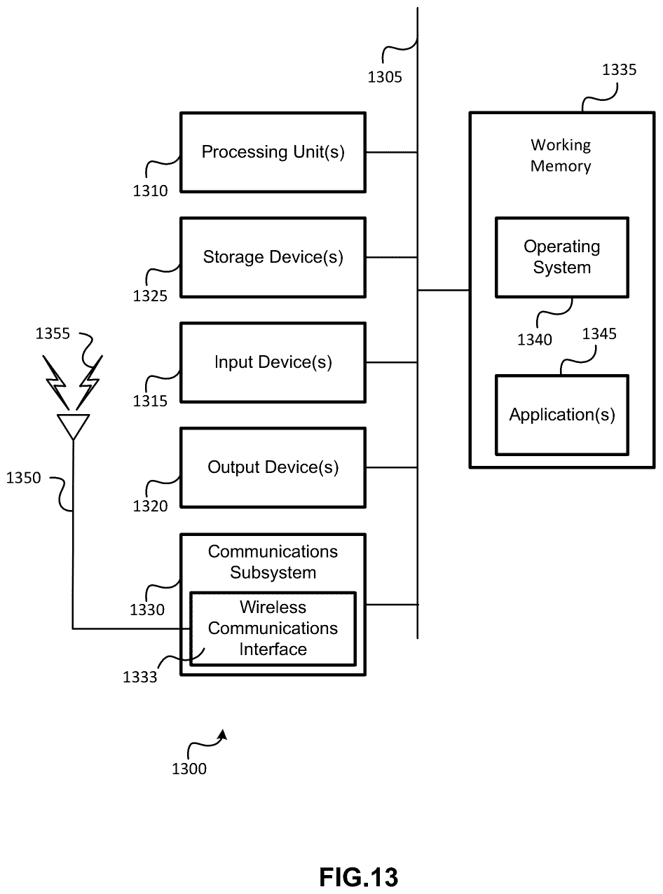

FIG. 10 is a flow diagram of a method 1000 of enabling efficient reporting of position measurements taken by a UE in a wireless communication network, according to an embodiment. In some aspects, the functionality of method 1000 illustrates the functionality performed by the location server 160 as shown in the flow diagram in FIG. 6. One or more of the functions illustrated in the blocks of FIG. 10 can be performed by a location server, which may be implemented by a computer system. Thus, means for performing the functionality illustrated in one or more of the blocks shown in FIG. 10 may be performed by hardware and/or software components of a computer system. Example components of a computer system are illustrated in FIG. 13, which is described in more detail below.

The functionality at block 1010 comprises determining, at a location server, identifying information for each PRS resource of a plurality of PRS resources to be measured by the UE during a positioning session between the UE and the location server. This determination may be based in part on an approximate location of the UE (e.g., from historical location information, serving TRP location information, etc.) to determine the TRPs from which the UE may measure PRS resources, based on locations of the TRPs. Additionally or alternatively, the determination may be involved on preliminary data exchanged with the UE prior to and/or at the beginning of a positioning session, such as capability information. Further, this determination may involve determining PRS resources to be transmitted by one or more TRPs during the course of the positioning session. The one or more TRPs may already be configured to transmit such PRS resources. Additionally or alternatively, the location server can configure the one or more TRPs to transmit PRS resources responsive to a request for determining a location of the UE. Again, the identifying information may comprise a PFL identifier, a TRP identifier, a physical cell identifier, an ARFCN identifier, a resource set identifier, or a resource identifier, or a combination thereof. Means for performing functionality at block 1010 may comprise, for example, a bus 1305, processing unit(s) 1310, communications subsystem 1330, working memory 1335, and/or other components of a computer system 1300 as illustrated in FIG. 13.

The functionality at block 1020 comprises generating, at the location server, for each PRS resource of the plurality of PRS resources, a sequence identifier of the respective PRS based on the identifying information wherein the sequence identifier is unique within the positioning session. Again, sequence identifiers may be based on a priority of the PRS resources. Thus, according to some embodiments, for each PRS resource of the plurality of PRS resources, generating the sequence identifier of the respective PRS resource based on the identifying information may comprise determining a priority of the respective PRS resource based on the identifying information, and generating the sequence identifier of the respective PRS resource based on the priority of the respective PRS resource. Further, as previously described in relation to FIGS. 4, 5, and 8, priority information can be implied in hierarchical structure of the PRS resource sequence of a positioning session, where the hierarchical structure is described by the identifying information determined at block 1010. From this, PRS resource sequence IDs (e.g., index numbers) can be designated for each PRS resource. Means for performing functionality at block 1020 may comprise, for example, a bus 1305, processing unit(s) 1310, communications subsystem 1330, working memory 1335, and/or other components of a computer system 1300 as illustrated in FIG. 13.

The functionality at block 1030 comprises sending AD to a wireless node, wherein the AD comprises the sequence identifier of each PRS resource of the plurality of PRS resources. Again, the wireless node may comprise a serving TRP of the UE or a second UE. Alternatively, the wireless node may comprise the UE itself. As described in the embodiments herein, this inclusion of the sequence identifier of each PRS resource in the AD can allow a wireless node receiving the AD to simply use the sequence identifier of a PRS when reporting measurement information for the PRS. Although the identifying information for each PRS resource of a plurality of PRS resources may be included in the AD sent at block 1032 the wireless node to further help configure the wireless node to obtain measurements of PRS resources, such information may not be needed in reciprocal measurement reports provided by the wireless node and may therefore be omitted in such reports. Means for performing functionality at block 1030 may comprise, for example, a bus 1305, processing unit(s) 1310, communications subsystem 1330, working memory 1335, and/or other components of a computer system 1300 as illustrated in FIG. 13.

Again, embodiments may accommodate changes to the AD. Such embodiments may comprise, for example, determining, at the location server, an updated position of the UE, and, responsive to determining the updated position of the UE, determining, at a location server, updated AD that adds a PRS resource to the plurality of PRS resources, removes a PRS resource from the plurality of PRS resources, or both. Embodiments may further comprise determining, at the location server, for each of at least one PRS resource of the plurality of PRS resources, (i) a new priority of the at least one PRS resource, based on updated AD, and (ii) a new sequence identifier of the at least one PRS resource. The location server may then send, to the wireless node, the updated AD, wherein the updated AD includes the new sequence identifier of the at least one PRS resource.

As further indicated in FIG. 7, the location server can subsequently determine the location of the UE based on a measurement report (e.g., included in the location information received from the UE). Such embodiments may therefore comprise receiving, at the location server, a measurement report from the wireless node, wherein the measurement report comprises (i) measurement information regarding at least one PRS resource of the plurality of PRS resources and (ii) the sequence identifier of the at least one PRS resource, and determining a location of the UE based at least in part on the measurement report.

FIG. 11 illustrates an embodiment of a UE 1100, which can be utilized as described herein above (e.g., in association with FIGS. 1-10). For example, UE 1100 may correspond to a UE 105 and/or a wireless node as described herein. Accordingly, the UE 1100 can perform one or more of the functions of the method shown in FIG. 9. It should be noted that FIG. 11 is meant only to provide a generalized illustration of various components, any or all of which may be utilized as appropriate. Furthermore, as previously noted, the functionality of the UE discussed in the previously described embodiments may be executed by one or more of the hardware and/or software components illustrated in FIG. 11.

The UE 1100 is shown comprising hardware elements that can be electrically coupled via a bus 1105 (or may otherwise be in communication, as appropriate). The hardware elements may include a processing unit(s) 1110 which can include without limitation one or more general-purpose processors, one or more special-purpose processors (such as DSP chips, graphics acceleration processors, application specific integrated circuits (ASICs), and/or the like), and/or other processing structures or means. As shown in FIG. 11, some embodiments may have a separate DSP 1120, depending on desired functionality. Location determination and/or other determinations based on wireless communication may be provided in the processing unit(s) 1110 and/or wireless communication interface 1130 (discussed below). The UE 1100 also can include one or more input devices 1170, which can include without limitation one or more keyboards, touch screens, touch pads, microphones, buttons, dials, switches, and/or the like; and one or more output devices 1115, which can include without limitation one or more displays (e.g., touch screens), light emitting diodes (LEDs), speakers, and/or the like.

The UE 1100 may also include a wireless communication interface 1130, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 1100 to communicate with other devices as described in the embodiments above. The wireless communication interface 1130 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 1132 that send and/or receive wireless signals 1134. According to some embodiments, the wireless communication antenna(s) 1132 may comprise a plurality of discrete antennas, antenna arrays, or any combination thereof. The antenna(s) 1132 may be capable of transmitting and receiving wireless signals using beams (e.g., Tx beams and Rx beams). Beam formation may be performed using digital and/or analog beam formation techniques, with respective digital and/or analog circuitry. The wireless communication interface 1130 may include such circuitry.

Depending on desired functionality, the wireless communication interface 1130 may comprise a separate receiver and transmitter, or any combination of transceivers, transmitters, and/or receivers to communicate with base stations (e.g., ng-eNBs and gNBs) and other terrestrial transceivers, such as wireless devices and access points. The UE 1100 may communicate with different data networks that may comprise various network types. For example, a Wireless Wide Area Network (WWAN) may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project X3” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The UE 1100 can further include sensor(s) 1140. Sensor(s) 1140 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the UE 1100 may also include a Global Navigation Satellite System (GNSS) receiver 1180 capable of receiving signals 1184 from one or more GNSS satellites using an antenna 1182 (which could be the same as antenna 1132). Positioning based on GNSS signal measurement can be utilized to complement and/or incorporate the techniques described herein. The GNSS receiver 1180 can extract a position of the UE 1100, using conventional techniques, from GNSS satellites 110 of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 1180 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 1180 is illustrated in FIG. 11 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processing units, such as processing unit(s) 1110, DSP 1120, and/or a processing unit within the wireless communication interface 1130 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), a hatch filter, particle filter, or the like. The positioning engine may also be executed by one or more processing units, such as processing unit(s) 1110 or DSP 1120.

The UE 1100 may further include and/or be in communication with a memory 1160. The memory 1160 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1160 of the UE 1100 also can comprise software elements (not shown in FIG. 11), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1160 that are executable by the UE 1100 (and/or processing unit(s) 1110 or DSP 1120 within UE 1100). In an aspect, then such code and/or instructions can be used to configure and/or adapt a general-purpose computer (or other device) to perform one or more operations in accordance with the described methods.

FIG. 12 illustrates an embodiment of a TRP 1200, which can be utilized as described herein above (e.g., in association with FIGS. 1-11). For example, TRP 1200 may correspond to base station 120, gNB 210, ng-eNB 214, and/or a wireless node as described herein. It should be noted that FIG. 12 is meant only to provide a generalized illustration of various components, any or all of which may be utilized as appropriate.

The TRP 1200 is shown comprising hardware elements that can be electrically coupled via a bus 1205 (or may otherwise be in communication, as appropriate). The hardware elements may include a processing unit(s) 1210 which can include without limitation one or more general-purpose processors, one or more special-purpose processors (such as DSP chips, graphics acceleration processors, ASICs, and/or the like), and/or other processing structure or means. As shown in FIG. 12, some embodiments may have a separate DSP 1220, depending on desired functionality. Location determination and/or other determinations based on wireless communication may be provided in the processing unit(s) 1210 and/or wireless communication interface 1230 (discussed below), according to some embodiments. The TRP 1200 also can include one or more input devices, which can include without limitation a keyboard, display, mouse, microphone, button(s), dial(s), switch(es), and/or the like; and one or more output devices, which can include without limitation a display, light emitting diode (LED), speakers, and/or the like.

The TRP 1200 might also include a wireless communication interface 1230, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, cellular communication facilities, etc.), and/or the like, which may enable the TRP 1200 to communicate as described herein. The wireless communication interface 1230 may permit data and signaling to be communicated (e.g., transmitted and received) to UEs, other base stations/TRPs (e.g., eNBs, gNBs, and ng-eNBs), and/or other network components, computer systems, and/or any other electronic devices described herein. The communication can be carried out via one or more wireless communication antenna(s) 1232 that send and/or receive wireless signals 1234.

The TRP 1200 may also include a network interface 1280, which can include support of wireline communication technologies. The network interface 1280 may include a modem, network card, chipset, and/or the like. The network interface 1280 may include one or more input and/or output communication interfaces to permit data to be exchanged with a network, communication network servers, computer systems, and/or any other electronic devices described herein.

In many embodiments, the TRP 1200 may further comprise a memory 1260. The memory 1260 can include, without limitation, local and/or network accessible storage, a disk drive, a drive array, an optical storage device, a solid-state storage device, such as a RAM, and/or a ROM, which can be programmable, flash-updateable, and/or the like. Such storage devices may be configured to implement any appropriate data stores, including without limitation, various file systems, database structures, and/or the like.

The memory 1260 of the TRP 1200 also may comprise software elements (not shown in FIG. 12), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1260 that are executable by the TRP 1200 (and/or processing unit(s) 1210 or DSP 1220 within TRP 1200). In an aspect, then such code and/or instructions can be used to configure and/or adapt a general-purpose computer (or other device) to perform one or more operations in accordance with the described methods.

FIG. 13 is a block diagram of an embodiment of a computer system 1300, which may be used, in whole or in part, to provide the functions of one or more network components, including a location server, as described in the embodiments herein. It should be noted that FIG. 13 is meant only to provide a generalized illustration of various components, any or all of which may be utilized as appropriate. FIG. 13, therefore, broadly illustrates how individual system elements may be implemented in a relatively separated or relatively more integrated manner. In addition, it can be noted that components illustrated by FIG. 13 can be localized to a single device and/or distributed among various networked devices, which may be disposed at different geographical locations.

The computer system 1300 is shown comprising hardware elements that can be electrically coupled via a bus 1305 (or may otherwise be in communication, as appropriate). The hardware elements may include processing unit(s) 1310, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 1300 also may comprise one or more input devices 1315, which may comprise without limitation a mouse, a keyboard, a camera, a microphone, and/or the like; and one or more output devices 1320, which may comprise without limitation a display device, a printer, and/or the like.

The computer system 1300 may further include (and/or be in communication with) one or more non-transitory storage devices 1325, which can comprise, without limitation, local and/or network accessible storage, and/or may comprise, without limitation, a disk drive, a drive array, an optical storage device, a solid-state storage device, such as a RAM and/or ROM, which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 1300 may also include a communications subsystem 1330, which may comprise wireless communication technologies managed and controlled by a wireless communication interface 1333, as well as wired technologies (such as Ethernet, coaxial communications, universal serial bus (USB), and the like). The wireless communication interface 1333 may comprise one or more wireless transceivers may send and receive wireless signals 1355 (e.g., signals according to 5G NR or LTE) via wireless antenna(s) 1350. Thus the communications subsystem 1330 may comprise a modem, a network card (wireless or wired), an infrared communication device, a wireless communication device, and/or a chipset, and/or the like, which may enable the computer system 1300 to communicate on any or all of the communication networks described herein to any device on the respective network, including a UE, base stations/TRPs, and/or any other electronic devices described herein. Hence, the communications subsystem 1330 may be used to receive and send data as described in the embodiments herein.

In many embodiments, the computer system 1300 will further comprise a working memory 1335, which may comprise a RAM or ROM device, as described above. Software elements, shown as being located within the working memory 1335, may comprise an operating system 1340, device drivers, executable libraries, and/or other code, such as one or more applications 1345, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processing unit within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 1325 described above. In some cases, the storage medium might be incorporated within a computer system, such as computer system 1300. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 1300 and/or might take the form of source and/or installable code, which, upon compilation and/or installation on the computer system 1300 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1. A method of efficient reporting of position measurements taken by a User Equipment (UE) in a wireless communication network, the method comprising: receiving, at a wireless node, Assistance Data (AD) from a location server during a positioning session, wherein the AD includes identifying information for at least a first Position Reference Signal (PRS) resource of a plurality of PRS resources to be measured by the UE; obtaining, at the wireless node, measurement information regarding the first PRS resource; and sending a first measurement report from the wireless node to the location server, wherein the first measurement report comprises: the measurement information regarding the first PRS resource; and a sequence identifier of the first PRS resource, wherein the sequence identifier of the first PRS resource is generated from the identifying information for the first PRS resource, and wherein the sequence identifier of the first PRS resource is unique within the positioning session among sequence identifiers of the plurality of PRS resources.

Clause 2. The method of clause 1, wherein the sequence identifier of the first PRS resource is generated from the identifying information based on a priority of the first PRS resource determined from the identifying information.

Clause 3. The method of any of clauses 1-2, wherein the identifying information for the first PRS resource comprises: a Positioning Frequency Layer (PFL) identifier, a Transmission and Reception Point (TRP) identifier, a physical cell identifier, an Absolute Radio-Frequency Channel Number (ARFCN) identifier, a resource set identifier, or a resource identifier, or a combination thereof.

Clause 4. The method of any of clauses 1-3 further comprising: receiving, at a wireless node, updated AD from a location server, wherein the updated AD adds a PRS resource to the plurality of PRS resources, removes a PRS resource from the plurality of PRS resources, or both; obtaining measurement information regarding a second PRS resource; and sending a second measurement report to the location server, wherein the second measurement report comprises: the measurement information regarding the second PRS resource; and a sequence identifier of the second PRS resource, wherein the sequence identifier of the second PRS resource is generated from the updated AD.

Clause 5. The method of any of clauses 1-4, wherein the wireless node comprises a serving TRP of the UE or a second UE, and wherein obtaining the measurement information comprises receiving the measurement information wirelessly from the UE.

Clause 6. The method of any of clauses 1-4, wherein the wireless node comprises the UE.

Clause 7. The method of any of clauses 1-6, wherein the first measurement report further comprises an indication of a length of the sequence identifier of the first PRS resource.

Clause 8. The method of any of clauses 1-7, wherein the sequence identifier of the first PRS resource includes an indicator that the AD is received via unicast or broadcast.

Clause 9. The method of any of clauses 1-8, wherein the sequence identifier of the first PRS resource includes an indicator of a TRP via which the AD was received.

Clause 10. A method of enabling efficient reporting of position measurements taken by a User Equipment (UE) in a wireless communication network, the method comprising: determining, at a location server, identifying information for each Position Reference Signal (PRS) resource of a plurality of PRS resources to be measured by the UE during a positioning session; and sending Assistance Data (AD) to a wireless node, wherein the AD comprises, for each PRS resource of the plurality of PRS resources, a sequence identifier of the respective PRS resource generated from the identifying information of the respective PRS resource, wherein the sequence identifier is unique within the positioning session among sequence identifiers of the plurality of PRS resources.

Clause 11. The method of clause 10, wherein for each PRS resource of the plurality of PRS resources, the sequence identifier of the respective PRS resource is generated from the identifying information based on a priority of the respective PRS resource determined from the identifying information.

Clause 12. The method of any of clauses 10-11, wherein the identifying information comprises, for each PRS resource: a Positioning Frequency Layer (PFL), a Transmission and Reception Point (TRP), a physical cell identifier, an Absolute Radio-Frequency Channel Number (ARFCN), a resource set identifier, or a resource identifier, or a combination thereof.

Clause 13. The method of any of clauses 10-12 further comprising: determining, at the location server, an updated position of the UE; and responsive to determining the updated position of the UE, sending, from the location server to the wireless node, an updated AD, wherein the updated AD adds a PRS resource to the plurality of PRS resources, removes a PRS resource from the plurality of PRS resources, or both, and wherein the updated AD includes a new sequence identifier of at least one PRS resource of the plurality of PRS resources.

Clause 14. The method of any of clauses 10-13, wherein the wireless node comprises a serving TRP of the UE or a second UE.

Clause 15. The method of any of clauses 10-13, wherein the wireless node comprises the UE.

Clause 16. The method of any of clauses 10-15, wherein the AD includes the identifying information for each PRS resource of a plurality of PRS resources.

Clause 17. The method of any of clauses 10-16 further comprising: receiving, at the location server, a measurement report from the wireless node, wherein the measurement report comprises: measurement information regarding at least one PRS resource of the plurality of PRS resources; and the sequence identifier of the at least one PRS resource; and determining a location of the UE based at least in part on the measurement report.

Clause 18. A wireless node enabling efficient reporting of position measurements taken by a User Equipment (UE) in a wireless communication network, the wireless node comprising: a transceiver; a memory; and one or more processing units communicatively coupled with the transceiver and the memory, one or more processing units configured to: receive, via the transceiver, Assistance Data (AD) from a location server during a positioning session, wherein the AD includes identifying information for at least a first Position Reference Signal (PRS) resource of a plurality of PRS resources to be measured by the UE; obtain measurement information regarding the first PRS resource; and send, via the transceiver, a first measurement report from the wireless node to the location server, wherein the first measurement report comprises: the measurement information regarding the first PRS resource; and a sequence identifier of the first PRS resource, wherein the sequence identifier of the first PRS resource is generated from the identifying information for the first PRS resource, and wherein the sequence identifier of the first PRS resource is unique within the positioning session among sequence identifiers of the plurality of PRS resources.

Clause 19. The wireless node of clause 18, wherein, the one or more processing units are configured to generate the first PRS resource based on a priority of the first PRS resource determined from the identifying information.

Clause 20. The wireless node of any of clauses 18-19, wherein the one or more processing units are configured to determine, from the identifying information for the first PRS resource: a Positioning Frequency Layer (PFL) identifier, a Transmission and Reception Point (TRP) identifier, a physical cell identifier, an Absolute Radio-Frequency Channel Number (ARFCN) identifier, a resource set identifier, or a resource identifier, or a combination thereof.

Clause 21. The wireless node of any of clauses 18-20, wherein the one or more processing units are further configured to: receive, via the transceiver, updated AD from a location server, wherein the updated AD adds a PRS resource to the plurality of PRS resources, removes a PRS resource from the plurality of PRS resources, or both; obtain measurement information regarding a second PRS resource; and send, via the transceiver, a second measurement report to the location server, wherein the second measurement report comprises: the measurement information regarding the second PRS resource; and a sequence identifier of the second PRS resource, wherein the sequence identifier of the second PRS resource is generated from the updated AD.

Clause 22. The wireless node of any of clauses 18-21, wherein the wireless node comprises a serving TRP of the UE or a second UE, and wherein, to obtain the measurement information, the one or more processing units are configured to receive the measurement information wirelessly from the UE.

Clause 23. The wireless node of any of clauses 18-21, wherein the wireless node comprises the UE.

Clause 24. The wireless node of any of clauses 18-23, wherein the one or more processing units are configured to include, in the first measurement report, an indication of a length of the sequence identifier of the first PRS resource.

Clause 25. The wireless node of any of clauses 18-24, wherein the one or more processing units are configured to include, in the sequence identifier of the first PRS resource, an indicator that the AD is received via unicast or broadcast.

Clause 26. The wireless node of any of clauses 18-25, wherein the one or more processing units are configured to include, in the sequence identifier of the first PRS resource, an indicator of a TRP via which the AD was received.

Clause 27. A location server enabling efficient reporting of position measurements taken by a User Equipment (UE) in a wireless communication network, the location server comprising: a transceiver; a memory; and one or more processing units communicatively coupled with the transceiver and the memory, one or more processing units configured to: determine identifying information for each Position Reference Signal (PRS) resource of a plurality of PRS resources to be measured by the UE during a positioning session; and send Assistance Data (AD) to a wireless node via the transceiver, wherein the AD comprises, for each PRS resource of the plurality of PRS resources, a sequence identifier of the respective PRS resource generated from the identifying information of the respective PRS resource, wherein the sequence identifier is unique within the positioning session among sequence identifiers of the plurality of PRS resources.

Clause 28. The location server of clause 27, wherein, the one or more processing units configured are configured to generate the first PRS resource based on a priority of the first PRS resource determined from the identifying information.

Clause 29. The location server of any of clauses 27-28, wherein to determine the identifying information for each PRS resource, the one or more processing units configured are configured to determine: a Positioning Frequency Layer (PFL), a Transmission and Reception Point (TRP), a physical cell identifier, an Absolute Radio-Frequency Channel Number (ARFCN), a resource set identifier, or a resource identifier, or a combination thereof.

Clause 30. The location server of any of clauses 27-29, wherein the one or more processing units are further configured to: determine an updated position of the UE; and responsive to determining the updated position of the UE, send, to the wireless node via the transceiver, an updated AD, wherein the updated AD adds a PRS resource to the plurality of PRS resources, removes a PRS resource from the plurality of PRS resources, or both, and wherein the updated AD includes a new sequence identifier of at least one PRS resource of the plurality of PRS resources.

Clause 31. The location server of any of clauses 27-30 wherein, to send the AD to the wireless node, the one or more processing units are configured to send the AD to a serving TRP of the UE or a second UE. Clause 32. The location server of any of clauses 27-30 wherein, to send the AD to the wireless node, the one or more processing units are configured to send the AD to the UE. Clause 33. The location server of any of clauses 27-32, wherein the one or more processing units are configured to include, in the AD, the identifying information for each PRS resource of a plurality of PRS resources.

Clause 34. The location server of any of clauses 27-33, wherein the one or more processing units are further configured to: receive, via the transceiver, a measurement report from the wireless node, wherein the measurement report comprises: measurement information regarding at least one PRS resource of the plurality of PRS resources; and the sequence identifier of the at least one PRS resource; and determine a location of the UE based at least in part on the measurement report.

Clause 35. An apparatus, comprising: means for receiving Assistance Data (AD) from a location server during a positioning session, wherein the AD includes identifying information for at least a first Position Reference Signal (PRS) resource of a plurality of PRS resources to be measured by a User Equipment (UE); means for obtaining measurement information regarding the first PRS resource; and means for sending a first measurement report from a wireless node to the location server, wherein the first measurement report comprises: the measurement information regarding the first PRS resource; and a sequence identifier of the first PRS resource, wherein the sequence identifier of the first PRS resource is generated from the identifying information for the first PRS resource, and wherein the sequence identifier of the first PRS resource is unique within the positioning session among sequence identifiers of the plurality of PRS resources.

Clause 36. The apparatus of clause 35, further comprising means for generating the sequence identifier of the first PRS resource from the identifying information based on a priority of the first PRS resource determined from the identifying information.

Clause 37. The apparatus of any of clauses 35-36, wherein the identifying information for the first PRS resource comprises a Positioning Frequency Layer (PFL) identifier, a Transmission and Reception Point (TRP) identifier, a physical cell identifier, an Absolute Radio-Frequency Channel Number (ARFCN) identifier, a resource set identifier, or a resource identifier, or a combination thereof.

Clause 38. The apparatus of any of clauses 35-37 further comprising: means for receiving, at a wireless node, updated AD from a location server, wherein the updated AD adds a PRS resource to the plurality of PRS resources, removes a PRS resource from the plurality of PRS resources, or both means for obtaining measurement information regarding a second PRS resource; and means for sending a second measurement report to the location server, wherein the second measurement report comprises: the measurement information regarding the second PRS resource; and a sequence identifier of the second PRS resource, wherein the sequence identifier of the second PRS resource is generated from the updated AD.

Clause 39. The apparatus of any of clauses 35-38, wherein the wireless node comprises a serving TRP of the UE or a second UE, and wherein the means for obtaining the measurement information comprises means for receiving the measurement information wirelessly from the UE.

Clause 40. The apparatus of any of clauses 35-38, wherein the wireless node comprises the UE.

Clause 41. The apparatus of any of clauses 35-40, wherein the first measurement report further comprises an indication of a length of the sequence identifier of the first PRS resource.

Clause 42. The apparatus of any of clauses 35-41, wherein the sequence identifier of the first PRS resource includes an indicator that the AD is received via unicast or broadcast.

Clause 43. The apparatus of any of clauses 35-42, wherein the sequence identifier of the first PRS resource includes an indicator of a TRP via which the AD was received.

Clause 44. An apparatus, comprising: means for determining identifying information for each Position Reference Signal (PRS) resource of a plurality of PRS resources to be measured by a user equipment (UE) during a positioning session; and means for sending Assistance Data (AD) to a wireless node, wherein the AD comprises, for each PRS resource of the plurality of PRS resources, a sequence identifier of the respective PRS resource generated from the identifying information of the respective PRS resource, wherein the sequence identifier is unique within the positioning session among sequence identifiers of the plurality of PRS resources.

Clause 45. The apparatus of clause 44, further comprising means for generating for each PRS resource of the plurality of PRS resources, the sequence identifier of the respective PRS resource is generated from the identifying information based on a priority of the respective PRS resource determined from the identifying information.

Clause 46. The apparatus of any of clauses 44-45, wherein the identifying information comprises, for each PRS resource: a Positioning Frequency Layer (PFL), a Transmission and Reception Point (TRP), a physical cell identifier, an Absolute Radio-Frequency Channel Number (ARFCN), a resource set identifier, or a resource identifier, or a combination thereof.

Clause 47. The apparatus of any of clauses 44-46 further comprising: means for determining an updated position of the UE; and means for, responsive to determining the updated position of the UE, sending, from the apparatus to the wireless node, an updated AD, wherein the updated AD adds a PRS resource to the plurality of PRS resources, removes a PRS resource from the plurality of PRS resources, or both, and wherein the updated AD includes a new sequence identifier of at least one PRS resource of the plurality of PRS resources.

Clause 48. The apparatus of any of clauses 44-47, wherein the wireless node comprises a serving TRP of the UE or a second UE.

Clause 49. The apparatus of any of clauses 44-47, wherein the wireless node comprises the UE.

Clause 50. The apparatus of any of clauses 44-49, wherein AD includes the identifying information for each PRS resource of a plurality of PRS resources.

Clause 51. The apparatus of any of clauses 44-50 further comprising: means for receiving a measurement report from the wireless node, wherein the measurement report comprises: measurement information regarding at least one PRS resource of the plurality of PRS resources; and the sequence identifier of the at least one PRS resource; and means for determining a location of the UE based at least in part on the measurement report.

Clause 52. A non-transitory computer-readable medium storing instructions for efficient reporting of position measurements taken by a User Equipment (UE) in a wireless communication network, the instructions comprising code for: receiving, at a wireless node, Assistance Data (AD) from a location server during a positioning session, wherein the AD includes identifying information for at least a first Position Reference Signal (PRS) resource of a plurality of PRS resources to be measured by the UE; obtaining, at the wireless node, measurement information regarding the first PRS resource; and sending a first measurement report from the wireless node to the location server, wherein the first measurement report comprises: the measurement information regarding the first PRS resource; and a sequence identifier of the first PRS resource, wherein the sequence identifier of the first PRS resource is generated from the identifying information for the first PRS resource, and wherein the sequence identifier of the first PRS resource is unique within the positioning session among sequence identifiers of the plurality of PRS resources.

Clause 53. A non-transitory computer-readable medium storing instructions for enabling efficient reporting of position measurements taken by a User Equipment (UE) in a wireless communication network, the instructions comprising code for: determining, at a location server, identifying information for each Position Reference Signal (PRS) resource of a plurality of PRS resources to be measured by the UE during a positioning session; and sending Assistance Data (AD) to a wireless node, wherein the AD comprises, for each PRS resource of the plurality of PRS resources, a sequence identifier of the respective PRS resource generated from the identifying information of the respective PRS resource, wherein the sequence identifier is unique within the positioning session among sequence identifiers of the plurality of PRS resources.

What is claimed is:

1. A method of efficient reporting of position measurements taken by a User Equipment (UE) in a wireless communication network, the method comprising:
receiving, at a wireless node, Assistance Data (AD) from a location server during a positioning session, wherein the AD includes identifying information for at least a first Position Reference Signal (PRS) resource of a plurality of PRS resources to be measured by the UE;
obtaining, at the wireless node, measurement information regarding the first PRS resource; and
sending a first measurement report from the wireless node to the location server, wherein the first measurement report comprises:
the measurement information regarding the first PRS resource; and
a sequence identifier of the first PRS resource, wherein the sequence identifier of the first PRS resource is generated from the identifying information for the first PRS resource, and wherein the sequence identifier of the first PRS resource is unique within the positioning session among sequence identifiers of the plurality of PRS resources.

2. The method of claim 1, wherein the sequence identifier of the first PRS resource is generated from the identifying information based on a priority of the first PRS resource determined from the identifying information.

3. The method of claim 1, wherein the identifying information for the first PRS resource comprises:
a Positioning Frequency Layer (PFL) identifier,
a Transmission and Reception Point (TRP) identifier,
a physical cell identifier,
an Absolute Radio-Frequency Channel Number (ARFCN) identifier,
a resource set identifier, or
a resource identifier, or
a combination thereof.

4. The method of claim 1, further comprising:
receiving, at a wireless node, updated AD from a location server, wherein the updated AD adds a PRS resource to the plurality of PRS resources, removes a PRS resource from the plurality of PRS resources, or both;
obtaining measurement information regarding a second PRS resource; and
sending a second measurement report to the location server, wherein the second measurement report comprises:
the measurement information regarding the second PRS resource; and
a sequence identifier of the second PRS resource, wherein the sequence identifier of the second PRS resource is generated from the updated AD.

5. The method of claim 1, wherein the wireless node comprises a serving TRP of the UE or a second UE, and wherein obtaining the measurement information comprises receiving the measurement information wirelessly from the UE.

6. The method of claim 1, wherein the wireless node comprises the UE.

7. The method of claim 1, wherein the first measurement report further comprises an indication of a length of the sequence identifier of the first PRS resource.

8. The method of claim 1, wherein the sequence identifier of the first PRS resource includes an indicator that the AD is received via unicast or broadcast.

9. The method of claim 1, wherein the sequence identifier of the first PRS resource includes an indicator of a TRP via which the AD was received.

10. A method of enabling efficient reporting of position measurements taken by a User Equipment (UE) in a wireless communication network, the method comprising:
determining, at a location server, identifying information for each Position Reference Signal (PRS) resource of a plurality of PRS resources to be measured by the UE during a positioning session; and
sending Assistance Data (AD) to a wireless node, wherein the AD comprises, for each PRS resource of the plurality of PRS resources, a sequence identifier of the respective PRS resource generated from the identifying information of the respective PRS resource, wherein the sequence identifier is unique within the positioning session among sequence identifiers of the plurality of PRS resources.

11. The method of claim 10, wherein for each PRS resource of the plurality of PRS resources, the sequence identifier of the respective PRS resource is generated from the identifying information based on a priority of the respective PRS resource determined from the identifying information.

12. The method of claim 10, wherein the identifying information comprises, for each PRS resource:
a Positioning Frequency Layer (PFL),
a Transmission and Reception Point (TRP),
a physical cell identifier,
an Absolute Radio-Frequency Channel Number (ARFCN),
a resource set identifier, or
a resource identifier, or
a combination thereof.

13. The method of claim 10, further comprising:
determining, at the location server, an updated position of the UE; and
responsive to determining the updated position of the UE, sending, from the location server to the wireless node, an updated AD, wherein the updated AD adds a PRS resource to the plurality of PRS resources, removes a PRS resource from the plurality of PRS resources, or both, and wherein the updated AD includes a new sequence identifier of at least one PRS resource of the plurality of PRS resources.

14. The method of claim 10, wherein the wireless node comprises a serving TRP of the UE or a second UE.

15. The method of claim 10, wherein the wireless node comprises the UE.

16. The method of claim 10, wherein the AD includes the identifying information for each PRS resource of a plurality of PRS resources.

17. The method of claim 10, further comprising:
receiving, at the location server, a measurement report from the wireless node, wherein the measurement report comprises:
measurement information regarding at least one PRS resource of the plurality of PRS resources; and
the sequence identifier of the at least one PRS resource; and
determining a location of the UE based at least in part on the measurement report.

18. A wireless node enabling efficient reporting of position measurements taken by a User Equipment (UE) in a wireless communication network, the wireless node comprising:
a transceiver;
a memory; and
one or more processing units communicatively coupled with the transceiver and the memory, one or more processing units configured to:
receive, via the transceiver, Assistance Data (AD) from a location server during a positioning session, wherein
the AD includes identifying information for at least a first Position Reference Signal (PRS) resource of a plurality of PRS resources to be measured by the UE;
obtain measurement information regarding the first PRS resource; and
send, via the transceiver, a first measurement report from the wireless node to the location server, wherein the first measurement report comprises:
the measurement information regarding the first PRS resource; and
a sequence identifier of the first PRS resource, wherein the sequence identifier of the first PRS resource is generated from the identifying information for the first PRS resource, and wherein the sequence identifier of the first PRS resource is unique within the positioning session among sequence identifiers of the plurality of PRS resources.

19. The wireless node of claim 18, wherein, the one or more processing units are configured to generate the first PRS resource based on a priority of the first PRS resource determined from the identifying information.

20. The wireless node of claim 18, wherein the one or more processing units are configured to determine, from the identifying information for the first PRS resource:
a Positioning Frequency Layer (PFL) identifier,
a Transmission and Reception Point (TRP) identifier,
a physical cell identifier,
an Absolute Radio-Frequency Channel Number (ARFCN) identifier,
a resource set identifier, or
a resource identifier, or
a combination thereof.

21. The wireless node of claim 18, wherein the one or more processing units are further configured to:
receive, via the transceiver, updated AD from a location server, wherein the updated AD adds a PRS resource to the plurality of PRS resources, removes a PRS resource from the plurality of PRS resources, or both;
obtain measurement information regarding a second PRS resource; and
send, via the transceiver, a second measurement report to the location server, wherein the second measurement report comprises:
the measurement information regarding the second PRS resource; and
a sequence identifier of the second PRS resource, wherein the sequence identifier of the second PRS resource is generated from the updated AD.

22. The wireless node of claim 18, wherein the wireless node comprises a serving TRP of the UE or a second UE, and wherein, to obtain the measurement information, the one or more processing units are configured to receive the measurement information wirelessly from the UE.

23. The wireless node of claim 18, wherein the wireless node comprises the UE.

24. The wireless node of claim 18, wherein the one or more processing units are configured to include, in the first measurement report, an indication of a length of the sequence identifier of the first PRS resource.

25. The wireless node of claim 18, wherein the one or more processing units are configured to include, in the sequence identifier of the first PRS resource, an indicator that the AD is received via unicast or broadcast.

26. The wireless node of claim 18, wherein the one or more processing units are configured to include, in the sequence identifier of the first PRS resource, an indicator of a TRP via which the AD was received.

27. A location server enabling efficient reporting of position measurements taken by a User Equipment (UE) in a wireless communication network, the location server comprising:
a transceiver;
a memory; and
one or more processing units communicatively coupled with the transceiver and the memory, one or more processing units configured to:
determine identifying information for each Position Reference Signal (PRS) resource of a plurality of PRS resources to be measured by the UE during a positioning session; and
send Assistance Data (AD) to a wireless node via the transceiver, wherein the AD comprises, for each PRS resource of the plurality of PRS resources, a sequence identifier of the respective PRS resource generated from the identifying information of the respective PRS resource, wherein the sequence identifier is unique within the positioning session among sequence identifiers of the plurality of PRS resources.

28. The location server of claim 27, wherein, the one or more processing units configured are configured to generate the first PRS resource based on
a priority of the first PRS resource determined from the identifying information.

29. The location server of claim 27, wherein to determine the identifying information for each PRS resource, the one or more processing units configured are configured to determine:
a Positioning Frequency Layer (PFL),
a Transmission and Reception Point (TRP),
a physical cell identifier,
an Absolute Radio-Frequency Channel Number (ARFCN),
a resource set identifier, or
a resource identifier, or
a combination thereof.

30. The location server of claim 27, wherein the one or more processing units are further configured to:
determine an updated position of the UE; and
responsive to determining the updated position of the UE, send, to the wireless node via the transceiver, an updated AD, wherein the updated AD adds a PRS resource to the plurality of PRS resources, removes a PRS resource from the plurality of PRS resources, or both, and wherein the updated AD includes a new sequence identifier of at least one PRS resource of the plurality of PRS resources.

31. The location server of claim 27, wherein, to send the AD to the wireless node, the one or more processing units are configured to send the AD to a serving TRP of the UE or a second UE.

32. The location server of claim 27, wherein, to send the AD to the wireless node, the one or more processing units are configured to send the AD to the UE.

33. The location server of claim 27, wherein the one or more processing units are configured to include, in the AD, the identifying information for each PRS resource of a plurality of PRS resources.

34. The location server of claim 27, wherein the one or more processing units are further configured to:
receive, via the transceiver, a measurement report from the wireless node, wherein the measurement report comprises:
measurement information regarding at least one PRS resource of the plurality of PRS resources; and
the sequence identifier of the at least one PRS resource; and
determine a location of the UE based at least in part on the measurement report.

35. An apparatus, comprising:
means for receiving Assistance Data (AD) from a location server during a positioning session, wherein
the AD includes identifying information for at least a first Position Reference Signal (PRS) resource of a plurality of PRS resources to be measured by a User Equipment (UE);
means for obtaining measurement information regarding the first PRS resource; and
means for sending a first measurement report from a wireless node to the location server, wherein the first measurement report comprises:
the measurement information regarding the first PRS resource; and
a sequence identifier of the first PRS resource, wherein the sequence identifier of the first PRS resource is generated from the identifying information for the first PRS resource, and wherein the sequence identifier of the first PRS resource is unique within the positioning session among sequence identifiers of the plurality of PRS resources.

36. The apparatus of claim 35, further comprising means for generating the sequence identifier of the first PRS resource from the identifying information based on a priority of the first PRS resource determined from the identifying information.

37. The apparatus of claim 35, wherein the identifying information for the first PRS resource comprises:
a Positioning Frequency Layer (PFL) identifier,
a Transmission and Reception Point (TRP) identifier,
a physical cell identifier,
an Absolute Radio-Frequency Channel Number (ARFCN) identifier,
a resource set identifier, or
a resource identifier, or
a combination thereof.

38. The apparatus of claim 35, further comprising:
means for receiving, at a wireless node, updated AD from a location server, wherein the updated AD adds a PRS resource to the plurality of PRS resources, removes a PRS resource from the plurality of PRS resources, or both
means for obtaining measurement information regarding a second PRS resource; and
means for sending a second measurement report to the location server, wherein the second measurement report comprises:
the measurement information regarding the second PRS resource; and
a sequence identifier of the second PRS resource, wherein the sequence identifier of the second PRS resource is generated from the updated AD.

39. The apparatus of claim 35, wherein the wireless node comprises a serving TRP of the UE or a second UE, and wherein the means for obtaining the measurement information comprises means for receiving the measurement information wirelessly from the UE.

40. The apparatus of claim 35, wherein the wireless node comprises the UE.

41. The apparatus of claim 35, wherein the first measurement report further comprises an indication of a length of the sequence identifier of the first PRS resource.

42. The apparatus of claim 35, wherein the sequence identifier of the first PRS resource includes an indicator that the AD is received via unicast or broadcast.

43. The apparatus of claim 35, wherein the sequence identifier of the first PRS resource includes an indicator of a TRP via which the AD was received.

44. An apparatus, comprising:
means for determining identifying information for each Position Reference Signal (PRS) resource of a plurality of PRS resources to be measured by a user equipment (UE) during a positioning session; and
means for sending Assistance Data (AD) to a wireless node, wherein the AD comprises, for each PRS resource of the plurality of PRS resources, a sequence identifier of the respective PRS resource generated from the identifying information of the respective PRS resource, wherein the sequence identifier is unique within the positioning session among sequence identifiers of the plurality of PRS resources.

45. The apparatus of claim 44, further comprising means for generating for each PRS resource of the plurality of PRS resources, the sequence identifier of the respective PRS resource is generated from the identifying information based on a priority of the respective PRS resource determined from the identifying information.

46. The apparatus of claim 44, wherein the identifying information comprises, for each PRS resource:
a Positioning Frequency Layer (PFL),
a Transmission and Reception Point (TRP),
a physical cell identifier,
an Absolute Radio-Frequency Channel Number (ARFCN),
a resource set identifier, or
a resource identifier, or
a combination thereof.

47. The apparatus of claim 44, further comprising:
means for determining an updated position of the UE; and
means for, responsive to determining the updated position of the UE, sending, from the apparatus to the wireless node, an updated AD, wherein the updated AD adds a PRS resource to the plurality of PRS resources, removes a PRS resource from the plurality of PRS resources, or both, and wherein the updated AD includes a new sequence identifier of at least one PRS resource of the plurality of PRS resources.

48. The apparatus of claim 44, wherein the wireless node comprises a serving TRP of the UE or a second UE.

49. The apparatus of claim 44, wherein the wireless node comprises the UE.

50. The apparatus of claim 44, wherein AD includes the identifying information for each PRS resource of a plurality of PRS resources.

51. The apparatus of claim 44, further comprising:
means for receiving a measurement report from the wireless node, wherein the measurement report comprises:
measurement information regarding at least one PRS resource of the plurality of PRS resources; and
the sequence identifier of the at least one PRS resource; and
means for determining a location of the UE based at least in part on the measurement report.

52. A non-transitory computer-readable medium storing instructions for efficient reporting of position measurements taken by a User Equipment (UE) in a wireless communication network, the instructions comprising code for:
receiving, at a wireless node, Assistance Data (AD) from a location server during a positioning session, wherein
the AD includes identifying information for at least a first Position Reference Signal (PRS) resource of a plurality of PRS resources to be measured by the UE;
obtaining, at the wireless node, measurement information regarding the first PRS resource; and
sending a first measurement report from the wireless node to the location server, wherein the first measurement report comprises:
the measurement information regarding the first PRS resource; and
a sequence identifier of the first PRS resource, wherein the sequence identifier of the first PRS resource is generated from the identifying information for the first PRS resource, and wherein the sequence identifier of the first PRS resource is unique within the positioning session among sequence identifiers of the plurality of PRS resources.

53. A non-transitory computer-readable medium storing instructions for enabling efficient reporting of position measurements taken by a User Equipment (UE) in a wireless communication network, the instructions comprising code for:
determining, at a location server, identifying information for each Position Reference Signal (PRS) resource of a plurality of PRS resources to be measured by the UE during a positioning session; and
sending Assistance Data (AD) to a wireless node, wherein the AD comprises, for each PRS resource of the plurality of PRS resources, a sequence identifier of the respective PRS resource generated from the identifying information of the respective PRS resource, wherein the sequence identifier is unique within the positioning session among sequence identifiers of the plurality of PRS resources.
